(19) United States
(12) Patent Application Publication
(10) Pub. No.: US 2026/0103339 A1
(43) Pub. Date: Apr. 16, 2026

(54) REFUSE VEHICLE WITH ELECTRIC REACH APPARATUS

(71) Applicant: Oshkosh Corporation, Oshkosh, WI (US)

(72) Inventors: Wallace Buege, West Bend, WI (US); Martin Schimke, Red Granite, WI (US); Joshua D. Rocholl, Rochester, MN (US); Jerrod Kappers, Oshkosh, WI (US); Andrew Kotloski, Oshkosh, WI (US); Ryan Ullius, Oshkosh, WI (US); Jeremy Kiekhaefer, Oshkosh, WI (US)

(73) Assignee: Oshkosh Corporation, Oshkosh, WI (US)

(21) Appl. No.: 19/368,940

(22) Filed: Oct. 24, 2025

Related U.S. Application Data
(63) Continuation-in-part of application No. 18/399,544, filed on Dec. 28, 2023.
(60) Provisional application No. 63/435,928, filed on Dec. 29, 2022.
(60) Provisional application No. 63/712,115, filed on Oct. 25, 2024.
(60) Provisional application No. 63/712,098, filed on Oct. 25, 2024.
(60) Provisional application No. 63/712,106, filed on Oct. 25, 2024.
(60) Provisional application No. 63/712,091, filed on Oct. 25, 2024.

(51) Int. Cl. B65F 3/04; B65F 3/02

(52) U.S. Cl. CPC B65F 3/041; B65F 2003/023; B65F 2003/0266; B65F 2003/0269; B65F 2003/0276; B65F 2003/0279

(57) ABSTRACT

A reach assembly includes a body, a first extendable member, a second extendable member, a chain, and an electric motor. The first extendable member is received within and extendable from a first inner volume of the body. The second extendable member is received within and extendable from a second inner volume of the first extendable member. The chain is disposed within an inner volume of the second extendable member. The chain engages sprockets coupled at opposite ends of the first extendable member. The chain is fixed to the body at a first connection point and fixed to the second extendable member at a second connection point. The electric motor drives motion of the first extendable member relative to the body. Driving motion of the first extendable member relative to the body results in the second extendable member translating a corresponding degree of motion relative to the first extendable member.

### CROSS-REFERENCE TO RELATED APPLICATIONS

The present application is a continuation-in-part of U.S. patent application Ser. No. 18/399,544, filed Dec. 28, 2023, which claims the benefit of and priority to U.S. Provisional Ser. No. 63/435,928 , filed Dec. 29, 2022. The present application also claims the benefit of and priority to U.S. Provisional Ser. No. 63/712,115, filed Oct. 25, 2024, U.S. Provisional Ser. No. 63/712,098 , filed Oct. 25, 2024, U.S. Provisional Application No. 63/712,106, filed Oct. 25, 2024, and U.S. Provisional Application No. 63/712,091, filed Oct. 25, 2024. The entire contents of each of these applications is hereby incorporated by reference herein.

### BACKGROUND

The present disclosure relates to refuse vehicles. More specifically, the present disclosure relates to loading apparatuses for a refuse vehicle.

### SUMMARY

One embodiment relates to a refuse vehicle. The refuse vehicle includes a reach assembly, and a lift apparatus and grabber assembly. The reach assembly includes a body, a first extendable member, a second extendable member, a chain, and an electric motor. The body is coupled to the refuse vehicle. The body defines a first inner volume. The first extendable member is configured to be received within and extend from the first inner volume. The first extendable member defines a second inner volume. The second extendable member is configured to be received within and extend from the second inner volume. The chain is disposed within an inner volume of the second extendable member. The chain is configured to engage sprockets coupled at opposite ends of the first extendable member. The chain is fixed to the body at a first connection point and is fixed to the second extendable member at a second connection point. The electric motor is configured to drive motion of the first extendable member relative to the body. Driving relative motion of the first extendable member to the body results in the second extendable member translating a corresponding degree of motion relative to the first extendable member. The lift apparatus and grabber assembly are coupled with an end of the second extendable member.

In some embodiments, wherein the reach assembly includes a rack, and a drive assembly. The rack is positioned on the first extendable member. The drive assembly includes the electric motor and a pinion. The pinion is configured to engage the rack and be driven by the electric motor to drive translation of the first extendable member relative to the body.

In some embodiments, the drive assembly is fixedly coupled to the body. In some embodiments, the drive assembly further includes a gearbox configured to be driven by the electric motor and drive the pinion.

In some embodiments, the drive assembly further includes a turnbuckle fixed on opposite ends with ends of the chain. The turnbuckle is adjustable to adjust a tension of the chain. In some embodiments, the body includes a first access opening disposed proximate the turnbuckle and the first connection point in a bottom of the body. In some embodiments, the first access opening allows access to the turnbuckle and the first connection point.

In some embodiments, the body includes a second access opening disposed proximate the second connection point in a bottom of the body. In some embodiments, the second connection point is accessible through the second access opening and an opening in the second extendable member. In some embodiments, the reach assembly is configured to be driven between a retracted state and an extended state. In the retracted state, the first extendable member and the second extendable member are disposed within the first inner volume of the body and in the extended state, the first extendable member and the second extendable member are extended from the first inner volume of the body and protrude outwards from the first inner volume of the body.

In the retracted state, the first connection point is proximate an outer end of the first extendable member and the second connection point is proximate an inner end of the first extendable member. In some embodiments, in the extended state, the first connection point is proximate an inner end of the first extendable member and the second extendable member is proximate an outer end of the first extendable member.

In some embodiments, the first extendable member includes a pair of tracks disposed on opposite outer sides of the first extendable member. The pair of tracks are configured to receive linear bearings or rollers disposed on inner sides of the body.

In some embodiments, the reach assembly further includes a roller disposed on an eccentric shaft that is coupled with an end of the first extendable member. The roller is configured to engage an outer surface of the second extendable member. The eccentric shaft is rotatable to adjust a degree of engagement between the roller and the outer surface of the second extendable member.

Another embodiment of the present disclosure is a reach assembly for a refuse vehicle. The reach assembly includes a body, a first extendable member, a second extendable member, a chain, and an electric motor. The body is coupled to the refuse vehicle. The body defines a first inner volume. The first extendable member is configured to be received within and extend from the first inner volume. The first extendable member defines a second inner volume. The second extendable member is configured to be received within and extend from the second inner volume. The chain is disposed within an inner volume of the second extendable member. In some embodiments, the chain is configured to engage sprockets coupled at opposite ends of the first extendable member. The chain is fixed to the body at a first connection point and fixed to the second extendable member at a second connection point. The electric motor is configured to drive motion of the first extendable member relative to the body. Driving relative motion of the first extendable member to the body results in the second extendable member translating a corresponding degree of motion relative to the first extendable member.

In some embodiments, the reach assembly further includes a rack positioned on the first extendable member, and a drive assembly. The drive assembly includes the electric motor and a pinion. The pinion is configured to engage the rack and be driven by the electric motor to drive translation of the first extendable member relative to the body.

In some embodiments, the reach assembly further includes a turnbuckle fixed on opposite ends with ends of the chain. The turnbuckle is adjustable to adjust a tension of the chain.

In some embodiments, the body includes a first access opening disposed proximate a turnbuckle and the first connection point in a bottom of the body. The first access opening allows access to the turnbuckle and the first connection point.

The body includes a second access opening disposed proximate the second connection point in a bottom of the body. The second connection point is accessible through the second access opening and an opening in the second extendable member.

The first extendable member includes a pair of tracks disposed on opposite outer sides of the first extendable member. The pair of tracks are configured to receive linear bearings or rollers disposed on inner sides of the body. The reach assembly further includes a roller disposed on an eccentric shaft that is coupled with an end of the first extendable member. The roller is configured to engage an outer surface of the second extendable member. The eccentric shaft is rotatable to adjust a degree of engagement between the roller and the outer surface of the second extendable member.

Another embodiment of the present disclosure is a refuse vehicle. The refuse vehicle includes a reach assembly and a lift apparatus and grabber assembly. The reach assembly includes a body, a first extendable member, a second extendable member, a tensile member, and an electric motor. The body is coupled to the refuse vehicle. The body defines a first inner volume. The first extendable member is configured to be received within and extend from the first inner volume. The first extendable member defines a second inner volume. The second extendable member is configured to be received within and extend from the second inner volume. The tensile member is disposed within an inner volume of the second extendable member. The tensile member is configured to engage rotatable members coupled at opposite ends of the first extendable member. The tensile member is fixed to the body at a first connection point and fixed to the second extendable member at a second connection point. The electric motor is configured to drive motion of the first extendable member relative to the body. Driving relative motion of the first extendable member to the body results in the second extendable member translating a corresponding degree of motion relative to the first extendable member. The lift apparatus and grabber assembly are coupled with an end of the second extendable member.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a refuse vehicle including a side loading apparatus, according to some embodiments.

FIG. 2 is a perspective view of the side loading apparatus including an extension assembly and a lift assembly, according to some embodiments.

FIG. 3 is a perspective view of the lift assembly of FIG. 2 with a grabber assembly at a bottom position of the lift assembly, according to some embodiments.

FIG. 4 is a perspective view of the lift assembly of FIG. 2 with the grabber assembly at an upper position of the lift assembly, according to some embodiments.

FIG. 5 is a perspective view of the lift assembly of FIG. 2 with the grabber assembly at a top position of the lift assembly, according to some embodiments.

FIG. 6 is a side view of a portion of the lift assembly of FIG. 2 as the grabber assembly approaches the top position, according to some embodiments.

FIG. 7 is a side view of a portion of the lift assembly of FIG. 2 as the grabber assembly approaches the top position and begins a dumping operation, according to some embodiments.

FIG. 8 is a side view of a portion of the lift assembly of FIG. 2 as the grabber assembly reaches the top position and completes the dumping operation, according to some embodiments.

FIG. 9 is a perspective view of the extension assembly of FIG. 2, according to some embodiments.

FIG. 10 is a perspective sectional view of the extension assembly of FIG. 2, according to some embodiments.

FIG. 11 is a diagram of the extension assembly of FIG. 2, according to some embodiments.

FIG. 12 is a perspective view of the extension assembly of FIG. 2 at a fully retracted position, according to some embodiments.

FIG. 13 is a perspective view of the extension assembly of FIG. 2 at a partially extended position, according to some embodiments.

FIG. 14 is a perspective view of the extension assembly of FIG. 2 at a fully extended position, according to some embodiments.

FIG. 15 is a perspective view of the grabber assembly of FIG. 3, according to some embodiments.

FIG. 16 is a perspective sectional view of the grabber assembly of FIG. 3, according to some embodiments.

FIG. 17 is a perspective sectional view of a portion of the grabber assembly of FIG. 3, according to some embodiments.

FIG. 18 is a sectional view of a six degrees of freedom arm for a grabber assembly, according to some embodiments.

FIG. 19 is a side view of the six degrees of freedom arm of FIG. 18, according to some embodiments.

FIG. 20 is a flow diagram of a process for recommending a refuse vehicle for a collection route, according to some embodiments.

FIG. 21 is a perspective view of the refuse vehicle of FIG. 1 including the lift assembly, a reach assembly, and an unhinger apparatus, according to some embodiments.

FIG. 22 is a side view of an upper portion of the lift assembly and the unhinger apparatus with the grabber assembly approaching a top position, according to some embodiments.

FIG. 23 is a side view of the upper portion of the lift assembly and the unhinger apparatus with the grabber assembly beginning to rotate about a sprocket, according to some embodiments.

FIG. 24 is a side view of the upper portion of the lift assembly and the unhinger apparatus with the grabber assembly in a fully rotated position, according to some embodiments.

FIG. 25 is a perspective view of the upper portion of the lift assembly and the unhinger apparatus including a pair of members and engagement members, according to some embodiments.

FIG. 26 is another perspective view of the upper portion of the lift assembly and the unhinger apparatus including the pair of members and engagement members, according to some embodiments.

FIG. 27 is a perspective view of the upper portion of the lift assembly and the unhinger apparatus including a surface of a linkage configured to engage the engagement members, according to some embodiments.

FIG. 28 is a perspective view of the upper portion of the lift assembly and the unhinger apparatus with the grabber assembly in the fully rotated position, according to some embodiments.

FIG. 29 is a side view of the upper portion of the lift assembly and the unhinger apparatus with the grabber assembly apparatus pivotally coupled with a linkage that is configured to ascend or descend along a track of the lift assembly, according to some embodiments.

FIG. 30 is a perspective view of the upper portion of the lift assembly and the unhinger apparatus, according to some embodiments.

FIG. 31 is a perspective sectional view of the upper portion of the lift assembly and the unhinger apparatus, according to some embodiments.

FIG. 32 is a side sectional view of the upper portion of the lift assembly and the unhinger apparatus with the grabber assembly and a carriage in a partially rotated position, according to some embodiments.

FIG. 33 is a side sectional view of the upper portion of the lift assembly and the unhinger apparatus with the grabber assembly and a carriage in the fully rotated position, according to some embodiments.

FIG. 34 is another perspective view of the refuse vehicle of FIG. 1 including a reach assembly, according to an exemplary embodiment;

FIG. 35 is a perspective view of the reach assembly of FIG. 34 in an extended position or state, according to some embodiments;

FIG. 36 is a diagram of the reach assembly of FIG. 35 in a retracted position or state, according to some embodiments;

FIG. 37 is a diagram of the reach assembly of FIG. 35 in an extended position or state, according to some embodiments;

FIG. 38 is a side sectional view of the reach assembly of FIG. 35 in the retracted position or state, according to some embodiments;

FIG. 39 is a front view of the reach assembly of FIG. 35 in the retracted position or state, according to some embodiments;

FIG. 40 is a perspective view of the reach assembly of FIG. 35 in the retracted position or state, according to some embodiments;

FIG. 41 is a bottom perspective view of the reach assembly of FIG. 35 in the retracted position or state, according to some embodiments;

FIG. 42 is a perspective view of an outer end of the reach assembly of FIG. 35 in the retracted position or state, according to some embodiments;

FIG. 43 is a bottom perspective view of a first access opening of the reach assembly of FIG. 35, in the retracted position or state, according to some embodiments;

FIG. 44 is a side sectional view of a portion of the reach assembly of FIG. 35 in a retracted position or state with a chain of the reach assembly fixed to a body of the reach assembly, according to some embodiments;

FIG. 45 is a perspective sectional view of an outer portion of the reach assembly of FIG. 35 including a drive assembly, according to some embodiments;

FIG. 46 is a perspective sectional view of an inner portion of the reach assembly of FIG. 35 including a rear sprocket, according to some embodiments;

FIG. 47 is a perspective sectional view of the outer portion of the reach assembly of FIG. 35, according to some embodiments;

FIG. 48 is a perspective view of an end of the reach assembly of FIG. 35 including an adjustment mechanism for roller members, according to some embodiments; and

FIG. 49 is a perspective view of the adjustment mechanism of FIG. 48, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a refuse vehicle includes a lift assembly, an extension or reach assembly, and a grabber assembly. The reach assembly includes multiple sections that are telescopingly coupled with each other and configured to extend or retract. The lift assembly is coupled at an end of the reach assembly. The grabber assembly is coupled with and configured to ascend or descend the lift assembly. A motor that drives the grabber assembly to ascend or descend the lift assembly is positioned on the flit assembly and not on the grabber assembly to thereby reduce a mass of the grabber assembly. Further, the grabber assembly includes a single motor with a worm drive such that the grabber assembly is reduce din mass. The extension assembly is also configured, through a rack, and a chain and sprocket drive, to transfer linear relative translation between the sections from a single motor. The reach assembly can be a fully electric reach assembly that includes telescoping members. The telescoping members are received within each other and slidably couple with corresponding surfaces. The telescoping members can be driven to slidably translate relative to each other with an electric motor, an electric linear actuator, a gearing system, a rack and roller pinion system, a triple rack system, a chain system, etc. The reach assembly can be fixedly coupled with a refuse vehicle at a proximate end and may be configured to extend in a lateral direction of the refuse vehicle. The reach assembly includes a track and a grabber assembly at a distal end configured to releasably secure and lift/dump refuse containers.

The reach assembly advantageously provides multiple stages (e.g., multiple members that move in motion relative to each other) while only requiring a single drive assembly (e.g., only requiring driving motion of one member relative to another). For example, a telescoping arm may include a first member, a second member, and a third member, with the second member configured to move relative to the first member and the third member configured to move relative to the second member. Other systems require driving motion of the second member relative to the first member using a first drive and additionally driving motion of the third member relative to the second member using a second drive. Advantageously, the reach assembly includes a tensile member (e.g., a chain) that links motion of the second member relative to the first member with motion of the third member relative to the second member. The reach assembly can therefore provide two-stage motion (e.g., driving motion of the third member relative to the second member, and also driving motion of the second member relative to the first member) with a single drive (e.g., a single electric motor) that drives motion of the second member relative to the first member, or that drives motion of the third member relative to the second member.

### Refuse Vehicle

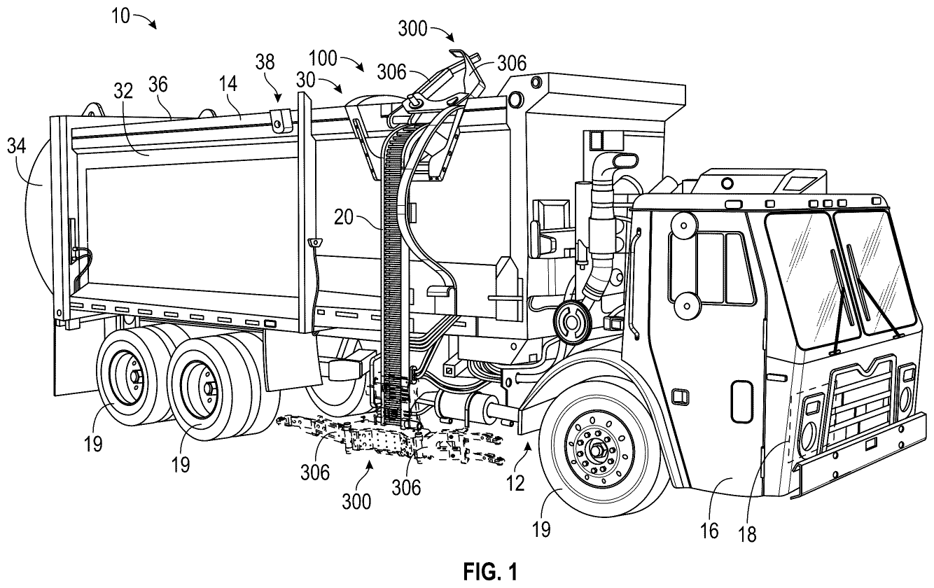

According to the exemplary embodiment shown in FIG. 1, a vehicle, shown as refuse vehicle 10 (e.g., a garbage truck, a waste collection truck, a sanitation truck, etc.), is configured as a side-loading refuse truck having a first lift mechanism/system (e.g., a side-loading lift assembly, etc.), shown as lift assembly 100. In other embodiments, the refuse vehicle 10 is configured as a front-loading refuse truck or a rear-loading refuse truck. In still other embodiments, the vehicle is another type of vehicle (e.g., a skid-loader, a telehandler, a plow truck, a boom lift, etc.). As shown in FIG. 1, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, switches, buttons, dials, etc.). As shown in FIG. 1, the refuse vehicle 10 includes a prime mover, shown as engine 18, coupled to the frame 12 at a position beneath the cab 16. The engine 18 is configured to provide power to a plurality of tractive elements, shown as wheels 19, and/or to other systems of the refuse vehicle 10 (e.g., a pneumatic system, a hydraulic system, etc.). The engine 18 may be configured to utilize one or more of a variety of fuels (e.g., gasoline, diesel, biodiesel, ethanol, natural gas, etc.), according to various exemplary embodiments. According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. According to an exemplary embodiment, a door, shown as top door 38, is movably coupled along the cover 36 to seal the opening thereby preventing refuse from escaping the refuse compartment 30 (e.g., due to wind, bumps in the road, etc.). Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment 30). In other embodiments, the storage volume is positioned between the hopper volume and the cab 16 (e.g., a rear-loading refuse vehicle, etc.).

As shown in FIG. 1, the refuse vehicle 10 includes a first lift mechanism/system (e.g., a front-loading lift assembly, etc.), shown as lift assembly 100. The lift assembly 100 includes a grabber assembly, shown as grabber assembly 300, movably coupled to a track, shown as track 20, and configured to move along an entire length of track 20. According to the exemplary embodiment shown in FIG. 1, the track 20 extends along substantially an entire height of the body 14 and is configured to cause the grabber assembly 300 to tilt near an upper height of the body 14. In other embodiments, the track 20 extends along substantially an entire height of body 14 on a rear side of the body 14.

Referring still to FIG. 1, the grabber assembly 300 includes a pair of grabber arms shown as grabber arms 306. The grabber arms 306 are configured to rotate about an axis extending through a bushing. The grabber arms 306 are configured to releasably secure a refuse container to the grabber assembly 300, according to an exemplary embodiment. The grabber arms 306 rotate about the axis extending through the bushing to transition between an engaged state and a disengaged state. In the engaged state, the grabber arms 306 are rotated towards each other such that the refuse container is grasped therein. In the disengaged state, the grabber arms 306 rotate outwards (as shown in FIG. 1) such that the refuse container is not grasped therein. By transitioning between the engaged state and the disengaged state, the grabber assembly 300 releasably connects the refuse container to the grabber assembly 300. The refuse vehicle 10 may pull up along-side the refuse container, such that the refuse container is positioned to be grasped by the grabber assembly 300 therein. The grabber assembly 300 may then transition into an engaged state to grasp the refuse container. After the refuse container has been securely grasped, the grabber assembly 300 may be transported along the track 20 with the refuse container. When the grabber assembly 300 reaches the end of the track 20, the grabber assembly 300 may tilt and empty the contents of the refuse container in the refuse compartment 30. The tilting is facilitated by the path of the track 20. When the contents of the refuse container have been emptied into the refuse compartment 30, the grabber assembly 300 may descend along the track 20 and return the refuse container to the ground. Once the refuse container has been placed on the ground, the grabber assembly 300 may transition into the disengaged state, releasing the refuse container.

### Lift Assembly

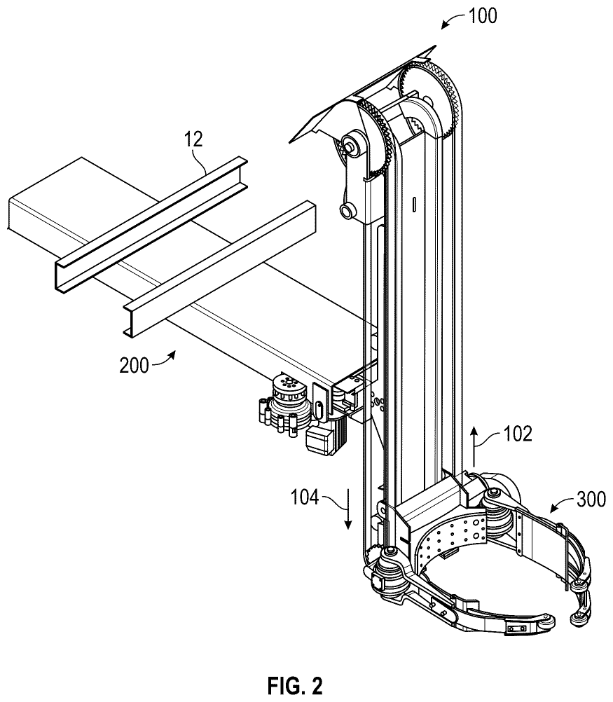

Referring to FIG. 2, the lift assembly 100 is shown coupled to an end of an extension assembly 200 (e.g., a reach assembly). The extension assembly 200 is coupled (e.g., fixed) with the frame 12 (e.g., a chassis of the refuse vehicle 10) and is configured to extend or retract the lift assembly 100 and therefore the grabber assembly 300 laterally outwards from the side of the refuse vehicle 10 to reach a refuse receptacle. In some embodiments, the extension assembly 200 is coupled with a portion of a fork of a front end loader refuse vehicle. The grabber assembly 300 is configured to travel in an upwards direction 102 along the lift assembly 100, and then travel in a downwards direction 104 along the lift assembly 100. In some embodiments, the lift assembly 100, the extension assembly 200, and the grabber assembly 300 are configured to perform a grasping, lifting, and dumping operation of a refuse container by (i) extending the extension assembly 200, (ii) grasping the refuse container with the grabber assembly 300 (e.g., between the grabber arms 306), (iii) retracting the extension assembly 200 to the refuse vehicle 10, (iv) lifting the grabber assembly 300 along the lift assembly 100 and dumping the contents of the refuse container, (v) returning the grabber assembly 300 to the ground, (vi) extending the extension assembly 200 and the grabber assembly 300 to its original location, and (vii) releasing the refuse container from the grabber assembly 300.

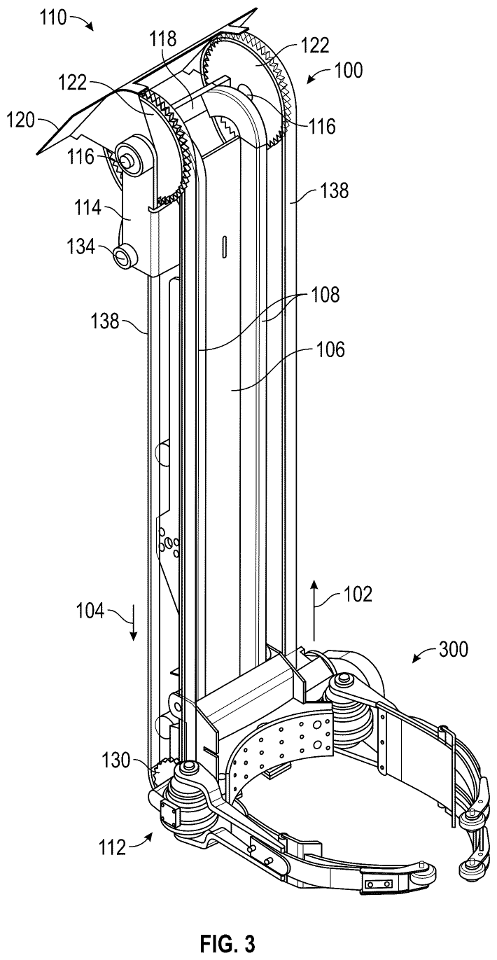

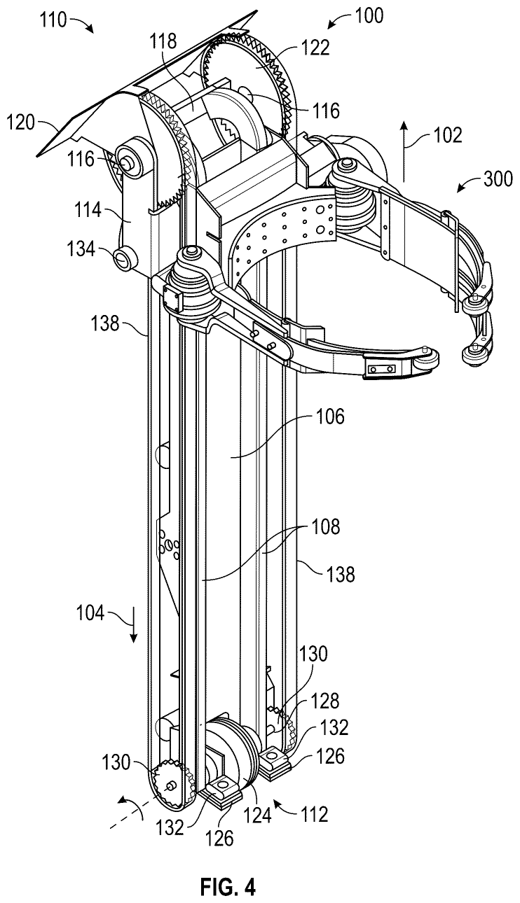

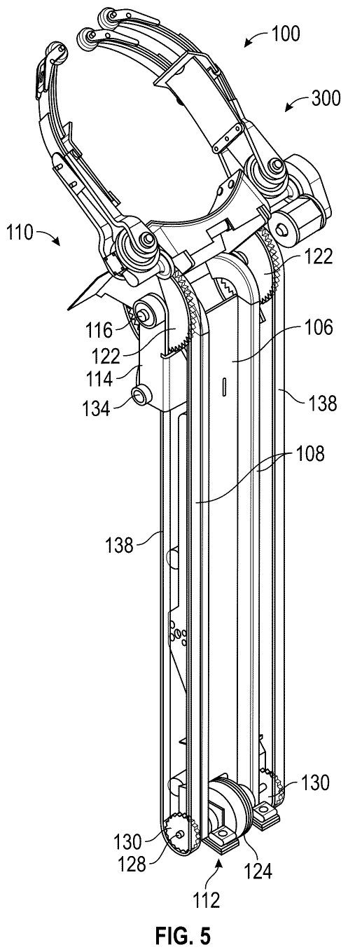

Referring to FIGS. 3-5, the lift assembly 100 includes a main member 106 (e.g., a body, a body member, a track member, a carriage, a mast, etc.) along which a pair of track members 108 are positioned. The track members 108 may be positioned at opposite sides of the main member 106. In some embodiments, the main member 106 has a U-shape. In some embodiments, the main member 106 defines multiple inward facing surfaces and a space for a portion of the grabber assembly 300 to translate, travel, climb, or ascend along.

The lift assembly 100 includes a pair of drive sprockets 130 positioned at a bottom end 112 of the main member 106, and a pair of follower sprockets 122 or follower members (e.g., guides, pulleys, rollers, sprockets, etc.) positioned at an upper end 110 of the main member 106. In some embodiments, the lift assembly 100 includes a drive motor 124 positioned at the bottom end 112 of the main member 106. The drive motor 124 is configured to operate to drive a pair of drive shafts 128 upon which the drive sprockets 130 are mounted. The lift assembly 100 also includes a pair of tensile members (e.g., chains, ropes, cables, bands, etc.), shown as chains 138 that extend between the drive sprockets 130 and the follower sprockets 122. The chains 138 are configured to drive the grabber assembly 300 to ascend or descend the lift assembly 100. Advantageously, the drive motor 124 (e.g., an electric motor) that is configured to drive the grabber assembly 300 to travel along the lift assembly 100 is positioned on the main member 106 and is not positioned on the grabber assembly 300. Accordingly, the grabber assembly 300 has a reduced weight or lift mass as compared to lift assemblies that have the drive motor positioned on the grabber assembly 300.

The lift assembly 100 also includes a pair of feet 126 (e.g., protrusions, edges, projections, etc.) that extend outwards from the main member 106 at the bottom end 112 of the main member 106. In some embodiments, a pair of stoppers or rubber members 132 are coupled with the pair of feet 126 and are configured to engage a bottom portion or surface of the grabber assembly 300 when the grabber assembly 300 is at a bottom most position along the lift assembly 100.

The lift assembly 100 also includes a pair of frame members 114 positioned at the upper end 110 of the main member 106. The frame members 114 may support the follower sprockets 122 which are rotatably coupled with the frame member 114 at the upper end 110 of the main member through shafts 116. The shafts 116 can be coupled with the frame members 114 through bearings to facilitate rotation of the follower sprockets 122. The lift assembly 100 also includes a bar 118 that extends between opposite sides of the main member 106 (e.g., between the pair of track members 108) to define a stopping surface for the grabber assembly 300 when the grabber assembly 300 reaches the upper end 110 of the lift assembly 100. In some embodiments, the lift assembly 100 also includes a shield 120 that extends between the follower sprockets 122. The shield 120 may define a boundary or surface that is sloped (e.g., towards an opening of the refuse compartment 30) so that refuse that falls out of the refuse container during dumping or emptying of the refuse container at the upper end 110 of the lift assembly 100 does not fall onto the lift assembly 100 (e.g., onto the chains 138, the follower sprockets 122, etc.). In some embodiments, the bar 118 facilitates limiting further linear motion or hinging of the carriage 304 at the upper end 110 of the lift assembly 100.

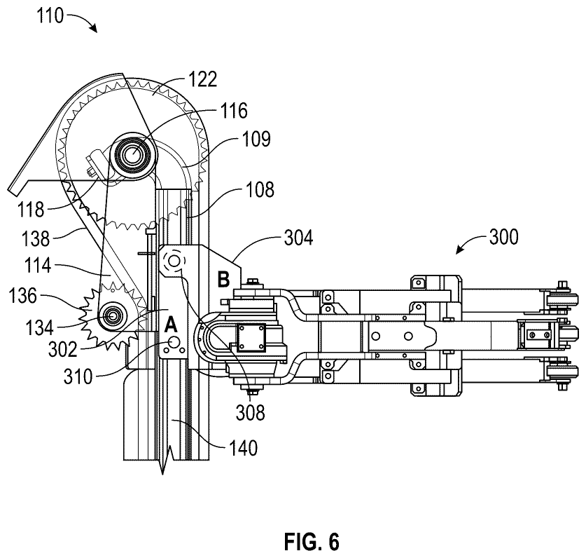

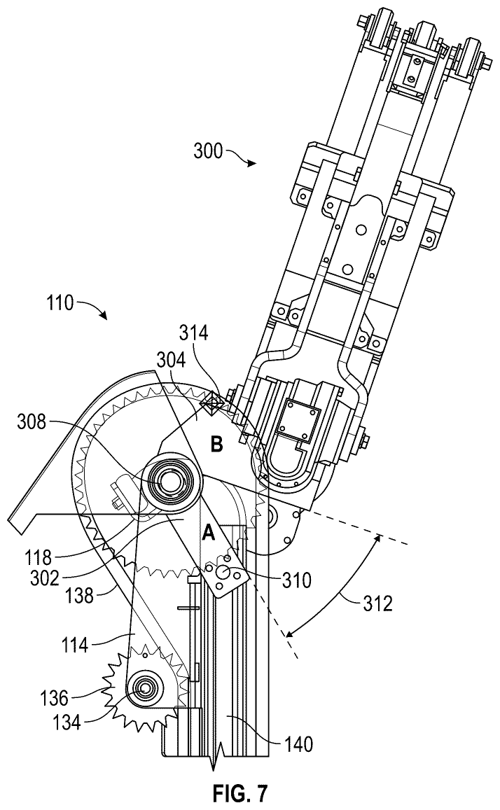

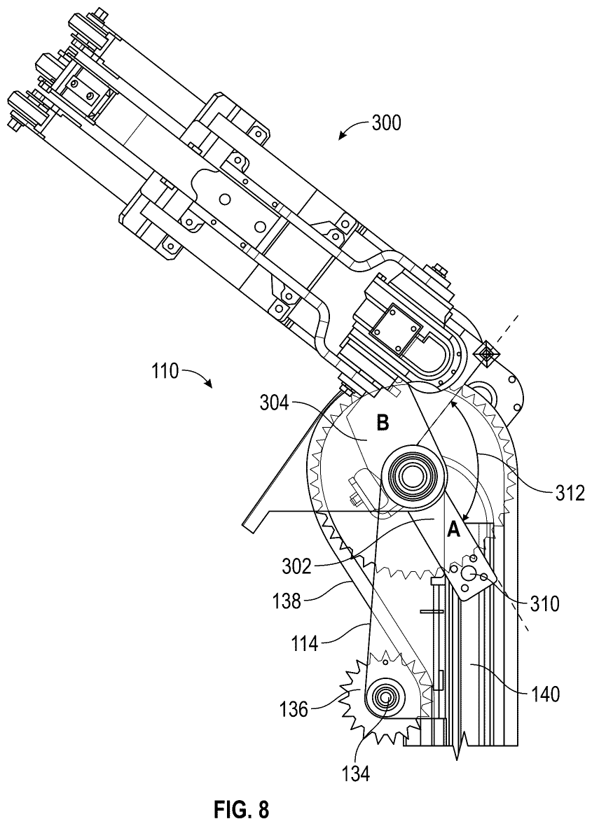

Referring to FIGS. 6-8, the lift assembly 100 includes a second pair of follower sprockets 136 that are rotatably coupled with the follower shafts 134 to the frame members 114 at a position rearward of the track members 108. In some embodiments, the second pair of follower sprockets 136 are configured to engage an opposite side of the chains 138 as the follower sprockets 122 and the drive sprockets 130. The second pair of follower sprockets 136 facilitate maintaining a thin profile of the chains 138 along the lift assembly 100 (e.g., alongside the track members 108).

The lift assembly 100 may include curved track members 109 that are positioned at an upper most or top end of the track members 108. In some embodiments, the curved track members 109 and the track members 108 define a groove, a channel, etc., shown as track 140 that has a J-shape (e.g., including a straight portion along the track members 108 and a curved portion along the curved track members 109). In some embodiments, a linkage 302 of the grabber assembly 300 is configured to follow along the track 140 (e.g., slide along the track 140). The linkage 302 may include a first member 308 (e.g., a slider bearing, a roller bearing, a block, etc.) and a second member 310. The first member 308 and the second member 310 may be received within the track 140 and are configured to slide along the track 140. In some embodiments, the curved track members 109 define a curved channel having a channel width that is greater than the channel width of the track 140 along the track members 108.

Referring still to FIGS. 6-8, the grabber assembly 300 includes a carriage 304 that is pivotally coupled with the linkage 302 at the first member 308. In some embodiments, the carriage 304 is pivotally coupled with the chains 138 at an engagement point 314 such that the chains 138, when driven, drive the carriage 304 and the grabber assembly 300 to ascend or descend the track 140. In some embodiments, the carriage 304 may lay flat along the linkage 302 as the grabber assembly 300 transports along the track members 108 as shown in FIG. 6.

When the grabber assembly 300 ascends to the upper end 110, the linkage 302 may be guided along the curved portion of the track 140, thereby resulting in a moment arm or distance between the first member 308 and the engagement point 314. As the chains 138 pull the carriage 304 at the engagement point 314, the carriage 304 is driven to tilt, thereby creating an angle 312 between the carriage 304 and the linkage 302 and causing the angle 312 to increase so that the refuse container that is grasped by the arms 306 empties contents of the refuse container into the refuse compartment 30. The drive motor 124 may then operate or control a descent of the grabber assembly 300 down the lift assembly 100 to the bottom end 112.

### Extension Assembly

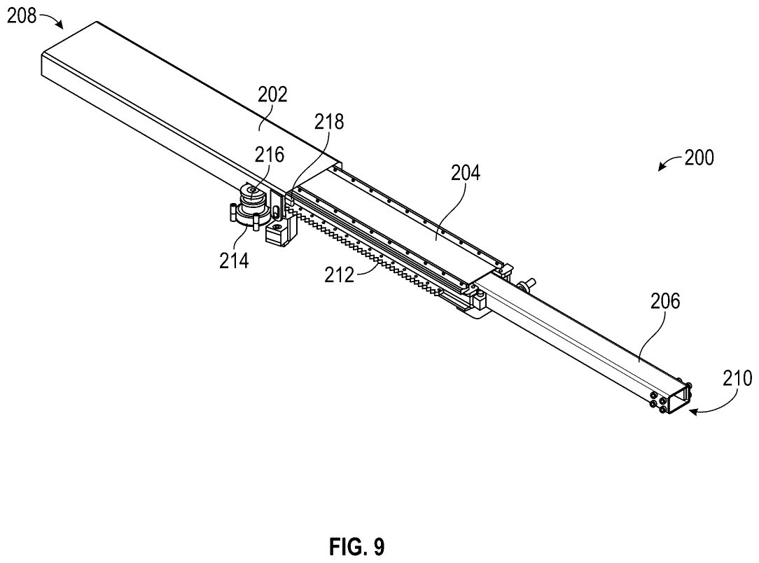

Referring to FIGS. 2 and 9, the extension assembly 200 may include a first member 202 (e.g., a first section, a fixed section, a fixed member, a receiving member, a telescoping member, etc.) that is fixedly coupled with the frame 12 of the refuse vehicle 10, a second member 204 (e.g., a medial member, a telescoping member, an intermediate member, a second section, etc.), and a third member 206 (e.g., a fly section, a distal member, an outer most member, a telescoping member, etc.). In some embodiments, the first member 202 is fixedly coupled with the frame 12 at an underside of the frame 12 such that the extension assembly 200 extends laterally outwards from the side of the refuse vehicle 10 at a position beneath the frame 12 or the body 14 of the refuse vehicle 10. In some embodiments, a first end 208 (e.g., a refuse end, a proximate end, a fixed end, etc.) of the extension assembly 200 is positioned beneath the refuse vehicle 10, and the lift assembly 100 and the grabber assembly 300 are mounted or coupled (e.g., fixedly coupled, mounted, rotatably coupled, pivotally coupled, adjustably coupled, etc.) on the third member 206 at a second end 210 of the extension assembly 200. In some embodiments, the second member 204 is configured to be received within an inner volume of the first member 202 and can be driven to extend or retract out of an opening of the first member 202. The third member 206 is similarly configured to be received within an inner volume of the second member 204 and is configured to extend or retract out of an opening of the second member 204 in a same direction as the second member 204 telescopes out of the first member 202, to thereby increase or decrease an overall length of the extension assembly 200, and laterally translate the lift assembly 100 and the grabber assembly 300 away from a side of the refuse vehicle 10.

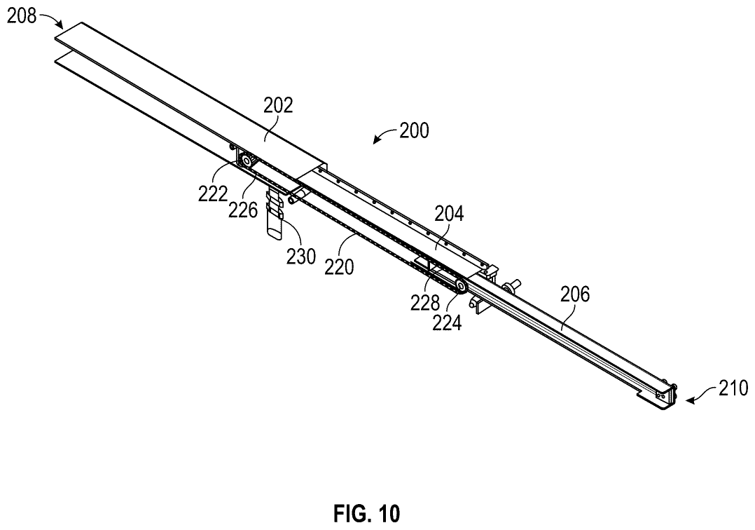

Referring to FIGS. 9 and 10, the second member 204 includes a rack 212 (e.g., a plurality of teeth) that extends lengthwise along a side of the second member 204. In some embodiments, the rack 212 is disposed in a longitudinal array and extends longitudinally along an outer surface of the second member 204. The extension assembly 200 also includes a rack motor 214 (e.g., an electric motor) configured to drive a pinion 216 which engages the rack 212 of the second member 204. A sensor 218 is coupled to the first member 202 and measures the status of the extension assembly 200. In some embodiments, the rack motor 214 and the pinion 216 are fixedly coupled with the first member 202 at an end of the first member 202 from which the second member 204 telescopes. In some embodiments, the pinion 216 is configured to access and engage with the rack 212 through a window or opening of the first member 202. The rack motor 214 may be configured to operate the second member 204 to extend or retract relative to the first member 202, which in turn drives the third member 206 to extend or retract relative to the second member 204. In this way, the rack motor 214 may be operated to drive extension or retraction of the entire extension assembly 200. In some embodiments, the rack motor 214 is operationally coupled with a controller or sensor and is configured to operate the extension assembly 200 to extend or retract based on a user input, sensor data that indicates a current amount of extension of the extension assembly 200, a predetermined function, a mode of operation of the refuse vehicle 10, etc.

The rack motor 214 is fixedly coupled with the first member 202 and drives the pinion 216 which engages the rack 212 of the second member 204 to thereby drive the second member 204 to linearly extend or retract relative to the first member 202. In some embodiments, the extension assembly 200 also includes a tensile member (e.g., a cable, a filament, a rope, a chain, etc.), shown as chain 220, which engages or is wound around a first guide (e.g., a roller, a smooth shaft, a pulley, a sprocket, a bearing, etc.), shown as first sprocket 222 (e.g., a gear), at a first or inner end of the second member 204, and a second guide (e.g., a roller, a smooth shaft, a pulley, a sprocket, a bearing, etc.), shown as second sprocket 224, at a second or outer end of the second member 204. In some embodiments, the first sprocket 222 and the second sprocket 224 are positioned within an inner volume of the second member 204. The first sprocket 222 and the second sprocket 224 are translatably fixedly coupled (e.g., mounted) and configured to rotate relative to the second member 204. In some embodiments, the chain 220 is fixedly coupled (e.g., secured, fastened, attached, etc.) with the first member 202 at a first point 226, and is fixedly coupled (e.g., secured, fastened, attached, etc.) with the third member 206 at a second point 228 along the chain 220. In some embodiments, the extension assembly 200 includes an electric brake 230 that is mounted on the first member 202 and configured to operate to engage the second member 204 to thereby lock a current extension position of the second member 204 relative to the first member 202.

In some embodiments, relative motion of the second member 204 relative to the first member 202 causes a same amount of motion relative between the third member 206 and the second member 204 due to motion of the chain 220 and fixed coupling of the chain 220 with the first member 202 at the first point 226 and fixed coupling of the chain 220 with the third member 206 at the second point 228. Advantageously, the extension assembly 200 includes a single drive motor, rack motor 214, which can operate to drive both the second member 204 to linearly translate relative to the first member 202 and to drive the third member 206 to linearly translate relative to the second member 204.

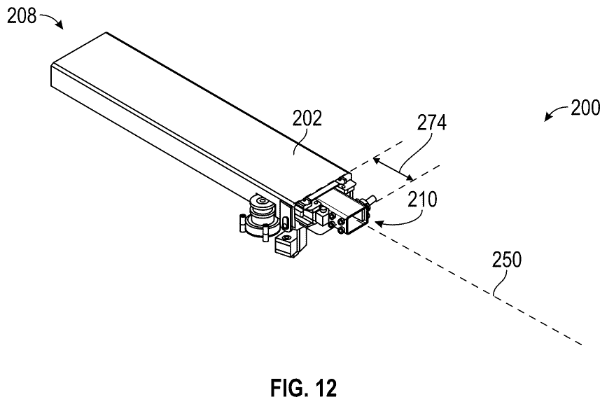

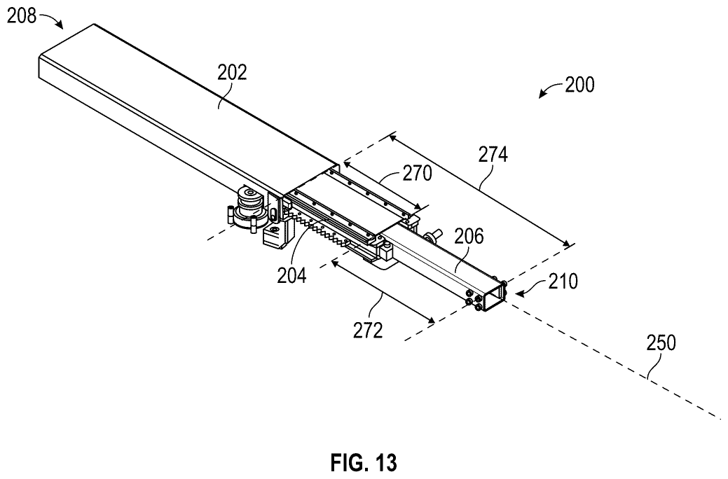

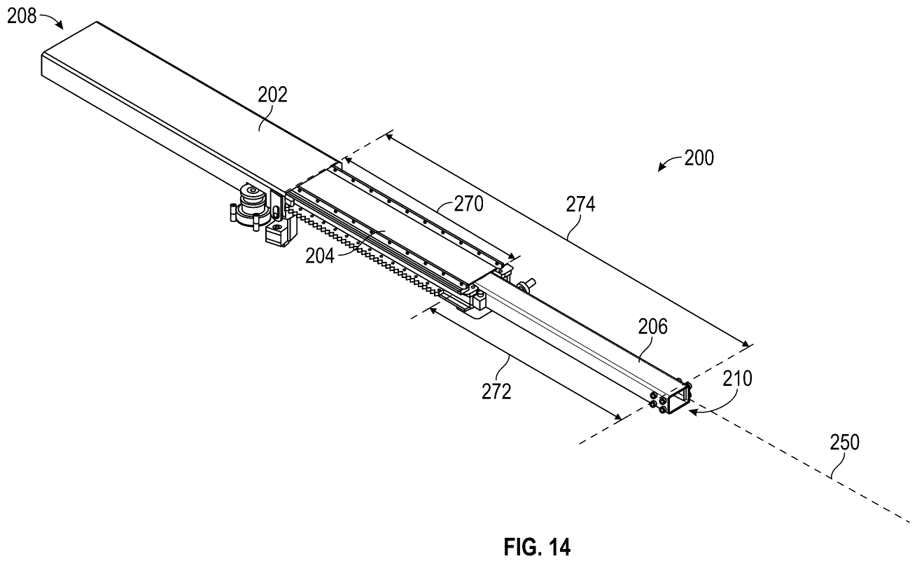

Referring to FIGS. 12-14, the extension assembly 200 is configured to operate to extend or retract to thereby increase or decrease a distance 274 defined between an end of the first member 202 and an end of the third member 206 (e.g., the second end 210) at which the lift assembly 100 and the grabber assembly 300 are coupled to reach a refuse container. In some embodiments, the distance 274 is measured along a longitudinal axis 250 that extends laterally relative to the refuse vehicle 10. In some embodiments, the distance 274 is defined as a sum of a distance 270 and a distance 272. The distance 270 is defined between the first member 202 and the end of the second member 204 and indicates an amount of extension or retraction of the second member 204 relative to the first member 202. The distance 272 is defined between the end of the second member 204 and the end of the third member 206 and indicates an amount of extension or retraction of the third member 206 relative to the second member 204. In some embodiments, the extension assembly 200 is configured to increase or decrease the distance 270 and the distance 272 at a same rate, such that the overall rate of change of the distance 274 is twice the rate of change of the distance 270, or the distance 272.

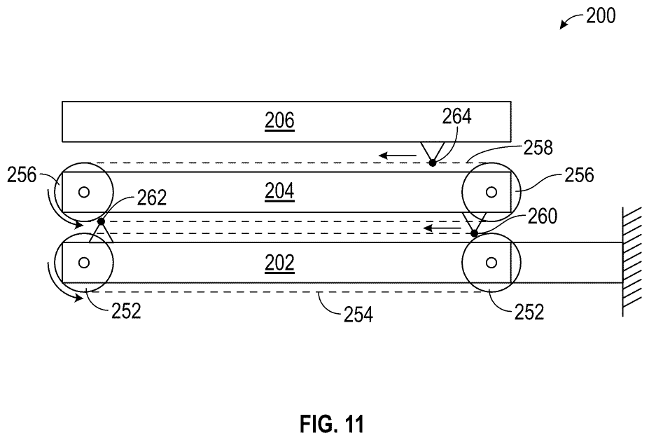

Referring particularly to FIG. 11, a diagram of the extension assembly 200 illustrates the operation of the extension assembly 200, with the rack 212 and the pinion 216 visualized as a pulley or chain and sprocket system. In some embodiments, the rack 212 and the pinion 216 are replaceable with a chain and sprocket system similar to the chain 220 and the first sprocket 222 and the second sprocket 224. The first member 202 is shown fixedly coupled (e.g., with the frame 12 of the refuse vehicle 10) and includes sprockets 252 positioned at opposite ends of the first member 202, with a tensile member, shown as chain 254, extending between and engaging the sprockets 252. In some embodiments, one of the sprockets 252 may be driven (e.g., by an electric motor) and the sprocket 252 may be a follower or idler sprocket.

The second member 204 also includes sprockets 256 and a tensile member, shown as chain 258, that extends around and engages the sprockets 256. In some embodiments, the first member 202 is fixed with the chain 258 at a connection point 262, and the second member 204 is fixed with the chain 254 at a connection point 260. The third member 206 is fixed with the chain 258 at a connection point 264. In this way, as the chain 254 is driven, the second member 204 is driven to linearly translate relative to the first member 202, which in turn causes a same amount of linear translation of the third member 206 relative to the second member 204.

### Grabber Assembly

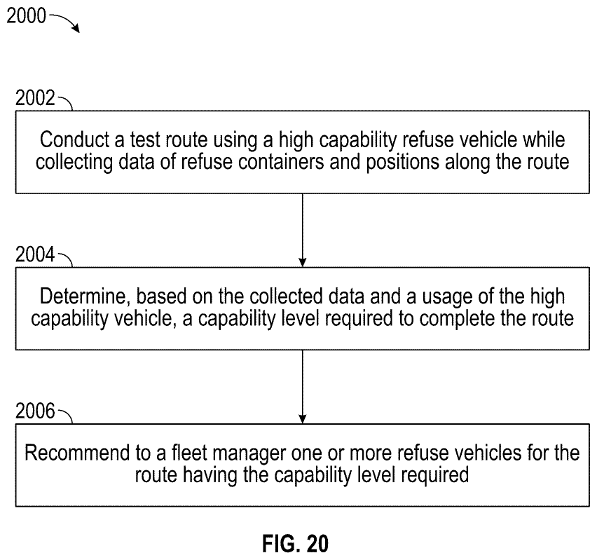

Referring to FIGS. 1-14, the grabber assembly 300 may be the same as or similar to the grabber assembly described with reference to FIGS. 20-22 of U.S. application Ser. No. 16/851,162, filed Apr. 17, 2020, the entire disclosure of which is incorporated by reference herein. The grabber assembly 300 may include a worm drive and a single motor for operating actuation of the grabber arms 306. In some embodiments, the grabber assembly 300 does not include a motor for transporting the grabber assembly 300 along the lift assembly 100 to thereby reduce weight of the grabber assembly 300.

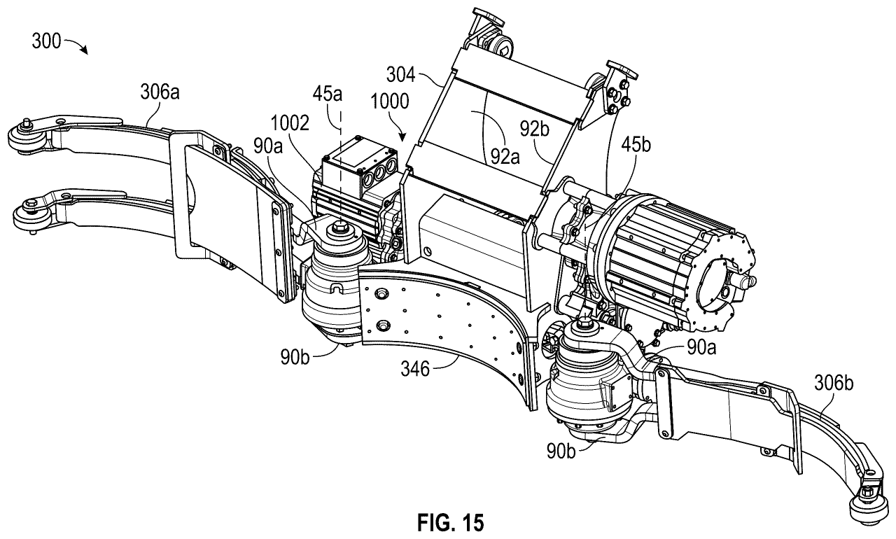

Referring particularly to FIGS. 15-17, the grabber assembly 300 is shown according to some embodiments. The grabber assembly 300 includes a first grabber arm 306a, a second grabber arm 306b, a body 346, and a carriage 304. The first grabber arm 306a is configured to rotatably or pivotally couple with the body 346 such that the first grabber arm 306a can rotate or pivot relative to body 346 about the first axis, shown as axis 45a. Likewise, the second grabber arm 306b is configured to rotatably or pivotally couple with the body 346 such that second grabber arm 306b can rotate or pivot relative to body 346 about a second axis, shown as axis 45b.

The grabber assembly 300 can include an electric gripping motor system 1000. The electric gripping motor system 1000 includes an electric motor, shown as gripping motor 1002 that is configured to operate to drive the first grabber arm 306a and the second grabber arm 306b to pivot or rotate relative to the body 346 about the axis 45a and the axis 45b, respectively.

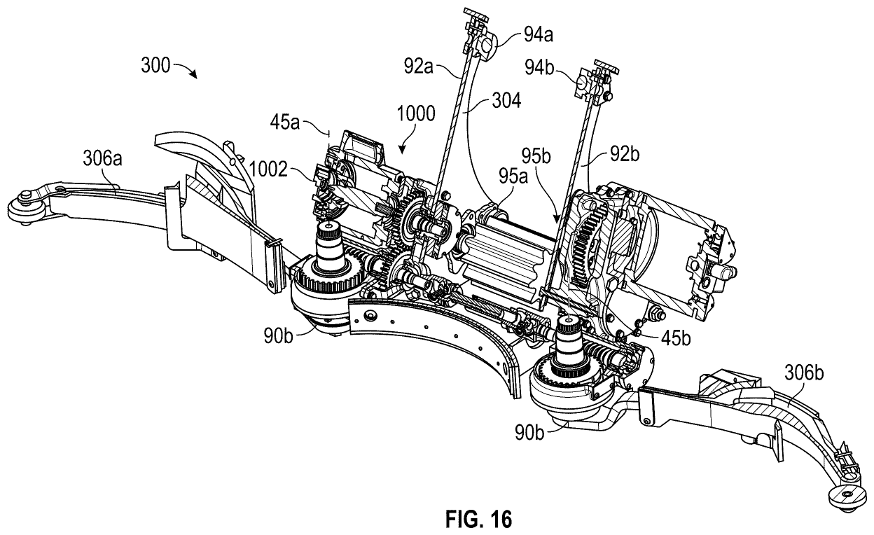

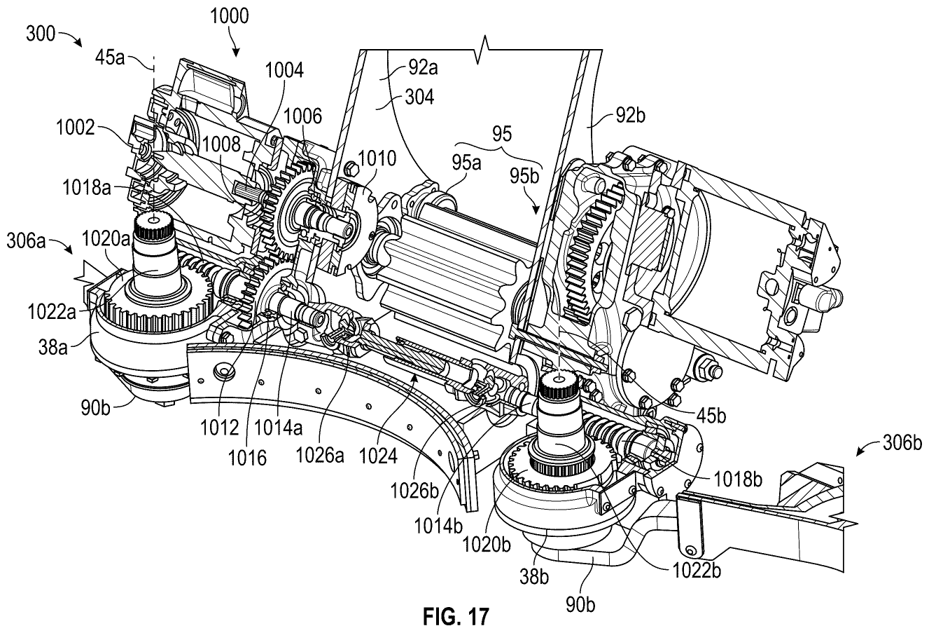

The carriage 304 can include a first lateral member 92a and a second lateral member 92b that are spaced a distance apart. The first lateral member 92a and the second lateral member 92b are substantially parallel with each other and spaced apart so that the first lateral member 92a may be positioned outside of the track 20, shown in FIG. 1, at a first lateral side of the track 20, and so that the second lateral member 92b may be positioned outside of the track 20 at a second lateral side of the track 20. Referring specifically to FIG. 16, the first lateral member 92a includes a first roller 94a and the second lateral member 92b includes a second roller 94b. The first roller 94a and the second roller 94b can be rotatably coupled with the first lateral member 92a and the second lateral member 92b, respectively, so that as the grabber assembly 300 ascends or descends along track 20, the first roller 94a and the second roller 94b rotate. In some embodiments, the first roller 94a and the second roller 94b are fixedly coupled with the first lateral member 92a and the second lateral member 92b, respectively. The first roller 94a can be received within a corresponding groove, track, recess, etc., of the track 20 (e.g., recess 96a shown in FIG. 17) and the second roller 94b can be received within a corresponding groove, track, recess, etc., of track 20 on an opposite lateral side of track 20 (e.g., recess 96b as shown in FIG. 17). The first roller 94a and the second roller 94b can be positioned at an upper end, or an upper portion of carriage 304. Carriage 304 can also include a second pair of rollers 95, shown as a first roller 95a and a second roller 95b, that are positioned at a lower end or lower portion of carriage 304 and are similarly configured to engage, be received within, etc., the tracks, grooves, recesses, etc., of track 20.

Referring particularly to FIG. 16, the electric gripping motor system 1000 includes the gripping motor 1002, an output driveshaft 1004, an output gear 1008, a driven gear 1012, and an electric brake 1010. The electric gripping motor system 1000 also includes a medial or an intermediate shaft assembly 1024 that is configured to deliver or transfer power provided by the gripping motor 1002 to the first grabber arm 306a and the second grabber arm 306b to drive the first grabber arm 306a and the second grabber arm 306b to pivot about the axis 45a and the axis 45b, respectively (e.g., to grasp and/or release a container or refuse bin).

The gripping motor 1002 is configured to operate to generate or provide rotational kinetic energy or torque that is transferred through the output driveshaft 1004. The output driveshaft 1004 may be rotatably coupled with the carriage 304 (e.g., the first lateral member 92a) through a bearing 1006 so that the output driveshaft 1004 is supported by the carriage 304 and can rotate relative to the carriage 304. In some embodiments, the output driveshaft 1004 is configured to be selectively engaged by the electric brake 1010. For example, the electric brake 1010 can receive an electrical current or electrical power from a battery, a power storage device, etc., of the refuse vehicle 10 and operate to engage, lock, interface with, etc., the output driveshaft 1004 so that the output driveshaft 1004 is locked at a current angular position or to restrict or prevent rotation of the output driveshaft 1004. In some embodiments, the electric brake 1010 is able to transition between a first position (e.g., an unlocked position) so that rotation of the output driveshaft 1004 is not limited (e.g., the output driveshaft 1004 is freely driven by the gripping motor 1002) and a second position (e.g., a locked position) so that rotation of the output driveshaft 1004 is limited, prevented, restricted, etc. (e.g., so that the output driveshaft 1004 is limited in its rotation or maintained at a current angular position or maintained within a specific angular range). The electric brake 1010 can transition between the first position and the second position in response to receiving a signal from the controller of the refuse vehicle 10.

The output gear 1008 engages, meshes with, etc., the driven gear 1012 and transfers rotational kinetic energy or torque to the driven gear 1012. The output gear 1008 and the driven gear 1012 can be spur gears, helical gears, etc., or any other types of gears. The driven gear 1012 may be rotatably coupled with a first shaft 1014a. In some embodiments, the first shaft 1014a is rotatably coupled with the carriage 304 (e.g., the first lateral member 92a) through a bearing 1016 so that the first shaft 1014a can rotate relative to the carriage 304. The first shaft 1014a includes a first end and a second end. The first end of the first shaft 1014a can include screw threads, worm threads, a worm drive, etc., shown as a first worm 1018a. The first worm 1018a is configured to engage, mesh with, etc., a first worm gear 1020a that is rotatably fixedly coupled with a first grabber arm shaft 1022a. The first grabber arm shaft 1022a can be the same as or similar to first bushing 54a. In some embodiments, the first grabber arm shaft 1022a is the same as or similar to adapter assembly pin 60a.

The first grabber arm shaft 1022a may define the axis 45a. In some embodiments, the first grabber arm shaft 1022a is fixedly coupled at opposite ends with a first control arm 90a and a second control arm 90b of the first grabber arm 306a (shown in FIGS. 15-17). The first grabber arm shaft 1022a can be rotatably supported within a first housing or a first structural member 38a that is fixedly coupled with the body 346 and/or the carriage 304. In some embodiments, the first grabber arm shaft 1022a is rotatably coupled with the first structural member 38a through one or more bearings.

In this way, the gripping motor 1002 may be operated to drive the first grabber arm 306a to rotate about the axis 45a to grasp, grip, or otherwise removably couple with a container. The gripping motor 1002 outputs rotational kinetic energy or torque through the output driveshaft 1004 which is transferred to the output gear 1008. The output gear 1008 drives the driven gear 1012 which is rotatably coupled with first shaft 1014a so that rotational kinetic energy is transferred through driven gear 1012 to first shaft 1014a. The first shaft 1014a rotates to drive the first worm gear 1020a, the first grabber arm shaft 1022a, the first control arm 90a, the second control arm 90b, and the first grabber arm 306a to rotate about the axis 45a (e.g., to grasp and release a refuse container). The gripping motor 1002 can operate to drive the output driveshaft 1004 in a first direction to drive the first grabber arm 306a to rotate about the axis 45a in a first direction (e.g., inwards, counter-clockwise, etc.) to grasp a container and can operate to drive the output driveshaft 1004 in a second direction to drive the first grabber arm 306a to rotate about the axis 45a in a second or opposite direction (e.g., outwards, clockwise, etc.) to release a container.

In some embodiments, the first shaft 1014a extends in a direction that is substantially orthogonal or perpendicular to the axis 45a. The first shaft 1014a can rotatably couple (e.g., fixedly) with the intermediate shaft assembly 1024 through a first universal joint 1026a. The intermediate shaft assembly 1024 rotatably couples with the first shaft 1014a through the first universal joint 1026a at a first end of the intermediate shaft assembly 1024, and rotatably couples with a second shaft 1014b through a second universal joint 1026b at a second, opposite, or distal end of the intermediate shaft assembly 1024. The second universal joint 1026b can be the same as or similar to the first universal joint 1026a and/or may be mirrored so that whatever is said of the first universal joint 1026a may be said of the second universal joint 1026b. The second shaft 1014b can be the same as or similar to the first shaft 1014a so that whatever is said of the first shaft 1014a may be said of the second shaft 1014b and vice versa.

The second shaft 1014b includes a second worm 1018b that is the same as or similar to first worm 1018a. In some embodiments, the second worm 1018b has a thread direction that is opposite a thread direction of the first worm 1018a. The second worm 1018b is configured to engage, mesh with, etc., a second worm gear 1020b. The second worm gear 1020b can be the same as or similar to the first worm gear 1020a. The second worm gear 1020b receives rotational kinetic energy or torque from the second worm 1018b so that the second worm gear 1020b rotates about the axis 45b. The second worm gear 1020b is fixedly coupled with a second grabber arm shaft 1022b that is fixedly coupled with a first control arm 90a and second control arm 90b of the second grabber arm 306b (e.g., at opposite ends of second grabber arm shaft 1022b). In this way, the gripping motor 1002 can be used to drive both the first grabber arm 306a and the second grabber arm 306b to rotate about the axis 45a and the axis 45b, respectively. Specifically, the intermediate shaft assembly 1024 facilitates providing rotational kinetic energy or torque for both the first grabber arm 306a and the second grabber arm 306b.

The second grabber arm shaft 1022b may define the axis 45b. In some embodiments, the second grabber arm shaft 1022b is fixedly coupled at opposite ends with the first control arm 90a and the second control arm 90b of the second grabber arm 306b (shown in FIGS. 15-17). The second grabber arm shaft 1022b can be rotatably supported within a second housing or a second structural member 38b that is fixedly coupled with the body 346 and/or the carriage 304. In some embodiments, the second grabber arm shaft 1022b is rotatably coupled with the second structural member 38b through one or more bearings.

In some embodiments, the first universal joint 1026a and the second universal joint 1026b are optional. For example, the intermediate shaft assembly 1024 may extend in a direction between the first worm 1018a and the second worm 1018b without the first universal joint 1026a and the second universal joint 1026b. In some embodiments, the first worm 1018a and the second worm 1018b are formed directly or integrally formed with opposite ends of the intermediate shaft assembly 1024. The first universal joint 1026a and the second universal joint 1026b can facilitate accounting for any misalignment between the first worm 1018a and the second worm 1018b.

In other embodiments, the electric gripping motor system 1000 includes a first gripping motor 1002 and a second gripping motor 1002. The first gripping motor 1002 can be configured to drive the first grabber arm 306b to rotate about the axis 45a as shown in FIG. 17 without the intermediate shaft assembly 1024. The second gripping motor 1002 can be configured to independently drive the second grabber arm 306b to rotate about the axis 45b using a gear train similar to the output driveshaft 1004, the output gear 1008, the driven gear 1012, the first shaft 1014a, the first worm 1018a, and the first worm gear 1020a. In this way, a similar but mirrored gear train can be provided on an opposite side of the grabber assembly 300 with its own gripping motor 1002 for independently driving the second grabber arm 306b. The first gripping motor 1002 and the second gripping motor 1002 can operate cooperatively to independently drive each of the first grabber arm 306a and the second grabber arm 306b to grasp and release refuse containers.

In some embodiments, the first worm 1018a and the second worm 1018b function to provide locking functionality or to reduce a likelihood that the grabber arms 306 back-drive. For example, the first worm 1018a and the second worm 1018b may transfer rotational kinetic energy to the first worm gear 1020a and the second worm gear 1020b, respectively, to pivot the grabber arms 306 about the axis 45a and the axis 45b, respectively, and prevent, restrict, limit, or reduce the likelihood that the first worm 1018a and the second worm 1018b are back driven by rotation of the grabber arms 306 about the axis 45a and the axis 45b, respectively. In some embodiments, due to the anti-back driving characteristic of the engagement between the first worm 1018a and the first worm gear 1020a and the engagement between the second worm 1018b and the second worm gear 1020b, the electric brake 1010 is optional.

### Alternative Mounting Arrangements and Configurations

Referring to FIGS. 2-17, in some embodiments, the grabber assembly 300 is mounted between forks of a front end loader refuse vehicle. In some embodiments, the grabber assembly 300 can be operated to grasp a refuse collection bin or waste receptacle and arms of the front end loader upon which the grabber assembly 300 is mounted can be operated to dump the contents of the refuse collection bin or the waste receptacle into a hopper of the front end loader refuse vehicle. In some embodiments, the grabber assembly 300 is mounted on an end of the extension assembly 200 which is coupled between the forks of the front end loader. Advantageously, mounting the grabber assembly 300 and/or the extension assembly 200 on forks of the front end loader can facilitate improved visibility, and reduce a need for a side camera to view operational status of a side loading configuration of the grabber assembly 300. Further, mounting the grabber assembly 300 and/or the extension assembly on the forks of the front end loader (e.g., off the side of the forks, or between the forks in a frontwards direction) can reduce a footprint of the loading apparatus.

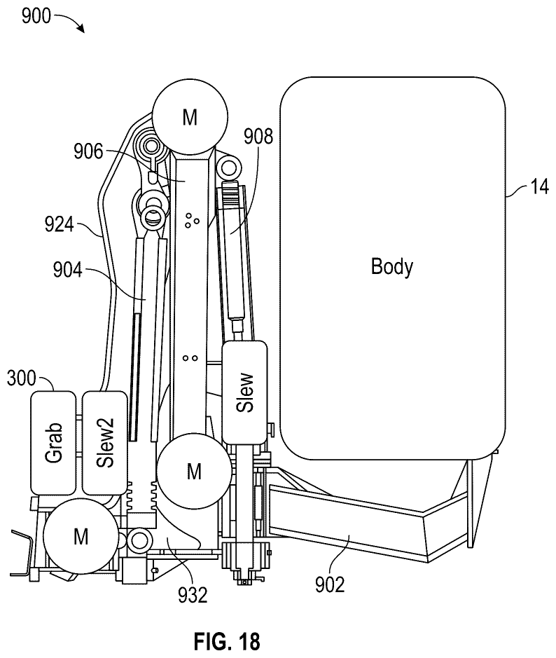

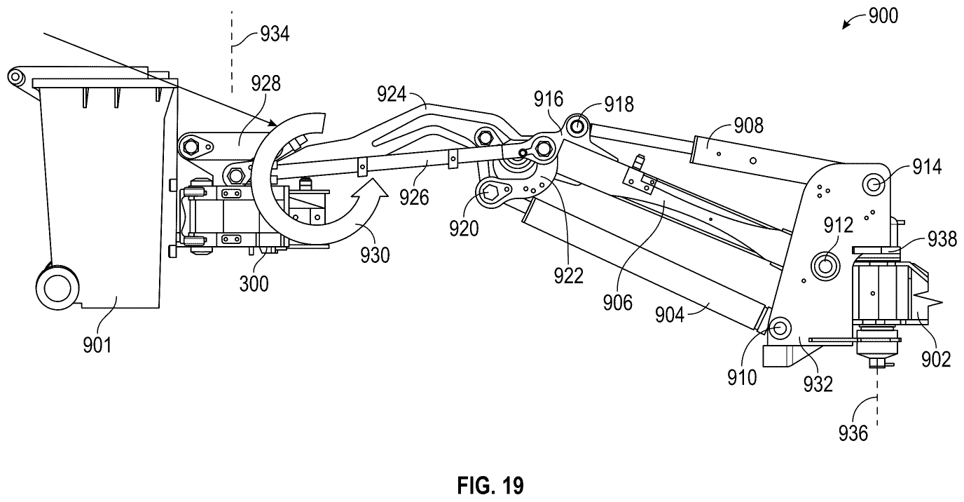

Referring to FIGS. 18-19, the grabber assembly 300 can be mounted on a six degree of freedom (“6-DOF”) arm, shown as 6-DOF arm 900. The 6-DOF arm 900 includes a frame 932 that is coupled with an extension member 902 which extends from the body 14 or the frame 12 of the refuse vehicle 10. In some embodiments, the 6-DOF arm 900 includes a first actuator 904 pivotally coupled with the frame 932 at a point 910, a second actuator 908 pivotally coupled with the frame 932 at a point 914, and a main member 906 pivotally coupled with the frame 932 at a point 912. In some embodiments, the second actuator 908 is configured to be driven by a slewing motor to extend or retract to thereby pivot about the point 914. In some embodiments, the 6-DOF arm 900 also includes an intermediate member 916, and an arm 924. The intermediate member 916 and the arm 924 may be pivotally coupled with each other. The first actuator 904 is pivotally coupled with the intermediate member 916 at a point 918. In some embodiments, the main member 906 is fixedly coupled with the intermediate member 916. In some embodiments, the 6-DOF arm 900 also includes a curved member 922 that extends between and pivotally couples with the first actuator 904 at a point 920 and pivotally couples with the intermediate member 916. The 6-DOF arm 900 may also include a linkage 926 that extends between the intermediate member 916 and an end of the arm 924. In some embodiments, a rotatable carriage 928 is positioned at an end of the arm 924 and the linkage 926. In some embodiments, the first actuator 904 and the second actuator 908 have slewing drives and corresponding electric motors configured to drive them to extend or retract. In some embodiments, the grabber assembly 300 can be driven to rotate about a Z-axis 934 of the rotatable carriage 928 by an electric motor in order to square the grabber assembly 300 with a refuse container 901. In some embodiments, the 6-DOF arm 900 is also rotatable or pivotable about an axis 936 of a rotatable coupling 938 relative to the extension member 902 and the refuse vehicle 10. In some embodiments, the grabber assembly 300 is also rotatable about a horizontal axis in a direction 930 or an opposite direction to facilitate alignment with the refuse container 901. The slewing drives of the first actuator 904 and the second actuator 908 can be configured to extend or retract the grabber assembly 300 from a side or front of the refuse vehicle 10. In some embodiments, the 6-DOF arm 900 is operable or controllable by a first joystick and a second joystick (e.g., in addition to a steering wheel of the refuse vehicle 10).

Referring to FIGS. 2-19 any of the grabber assembly 300, the extension assembly 200, the lift assembly 100, or the 6-DOF arm 900 are coupled with an intermediary container that is coupled to a pair of arms or forks of the refuse vehicle 10 (e.g., front end loader forks). In some embodiments, the intermediary container is a carry can. In some embodiments, the intermediary container is positioned on a front of the refuse vehicle 10 and is able to transition between a first position for collecting refuse and a second position for dumping the collected refuse into a main container (e.g., the refuse compartment 30). In some embodiments, the extension assembly 200, the lift assembly 100, and the grabber assembly 300 (or the 6-DOF arm 900) are coupled on the refuse container 202 as described in greater detail in U.S. application Ser. No. 16/047,903, filed Jul. 27, 2018, now U.S. Pat. No. 10,351,340, the entire disclosure of which is incorporated by reference herein.

### Process

Referring to FIG. 20, a flow diagram of a process 2000 for determining a type or model of refuse vehicle required to perform a collection route includes step 2002, step 2004, and step 2006, according to some embodiments. In some embodiments, process 2000 is performed to generate a recommendation for a fleet manager indicating which refuse vehicles can adequately complete the collection route and meet requirements along the route. Process 2000 can be performed by a server, a cloud computing system, or an on-site server at a refuse fleet facility.

Process 2000 includes conducting a test route using a high capability refuse vehicle while collecting data of refuse containers and positions along the route (step 2002), according to some embodiments. Step 2002 may also include monitoring usage data (e.g., load data) of a lifting apparatus of the refuse vehicle.

Process 2000 includes determining, based on the collected data, and a usage of the high capability vehicle, a capability level required to complete the route (step 2004), according to some embodiments. In some embodiments, step 2004 includes identifying a load or lifting ability required to complete a heaviest lift along the route and selecting a refuse vehicle having a suitable lift capacity (e.g., sufficiently sized electric or hydraulic motors).

Process 2000 includes recommending to a fleet manager one or more refuse vehicles for the route having the capability level required (step 2006), according to some embodiments. In some embodiments, step 2006 includes presenting (e.g., via a display screen) the recommendation to the fleet manager (e.g., in a web browser).

### Unhinger Assembly

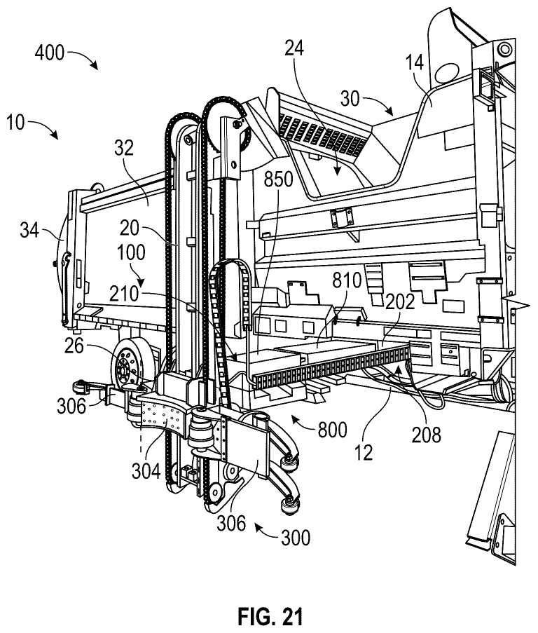

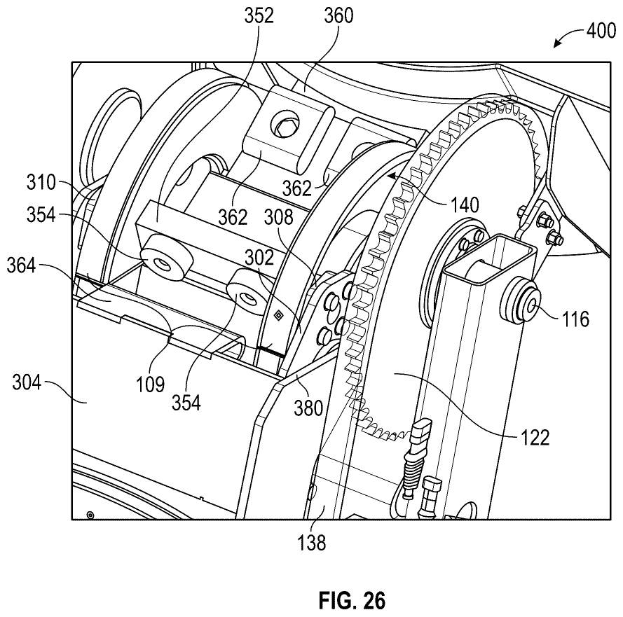

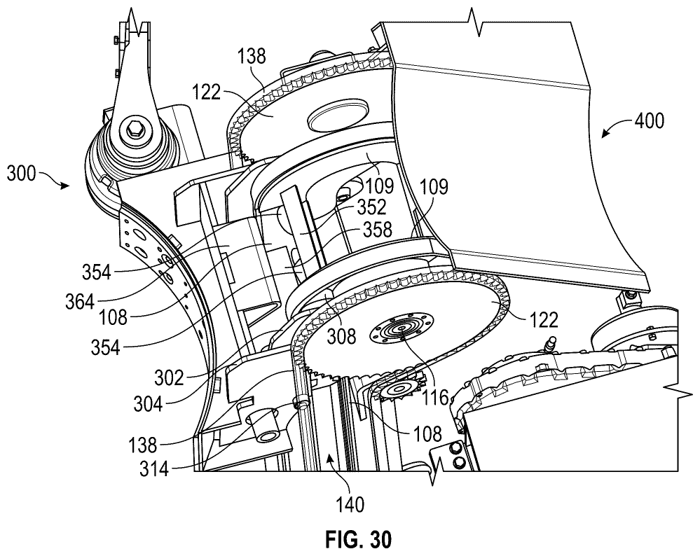

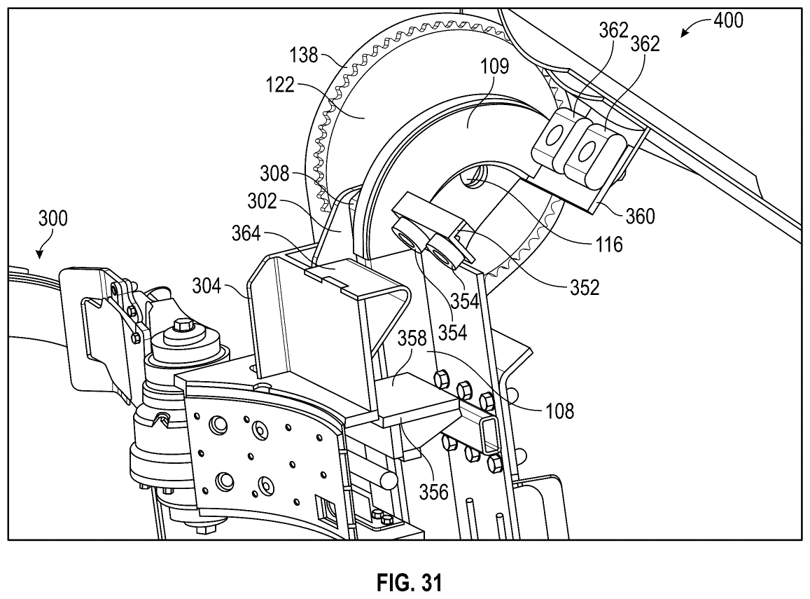

Referring to FIGS. 21-33, the unhinger apparatus 400 is disposed at the top of the track 20. The unhinger apparatus 400 is configured to induce the grabber assembly 300 to rotate about the sprockets 122 in a direction 350 (e.g., to tip a refuse container) in order to dump refuse from the container grasped by the grabber assembly 300 into the refuse compartment 30. The unhinger apparatus 400 can be similar to the unhinger apparatus 400 described in greater detail above with reference to FIGS. 1-8 (e.g., the linkage 302 and the carriage 304).

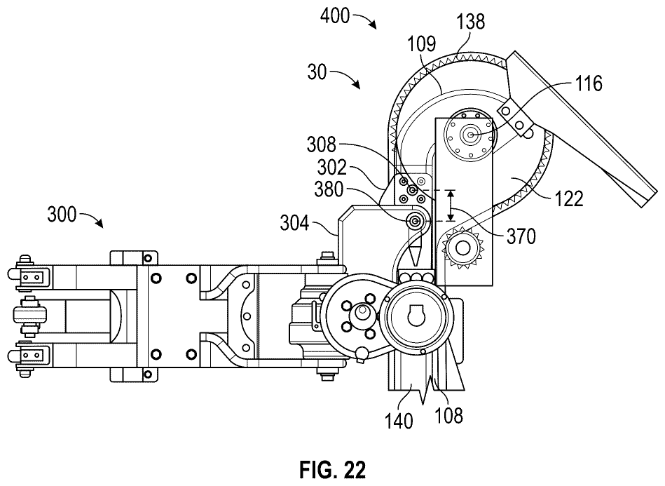

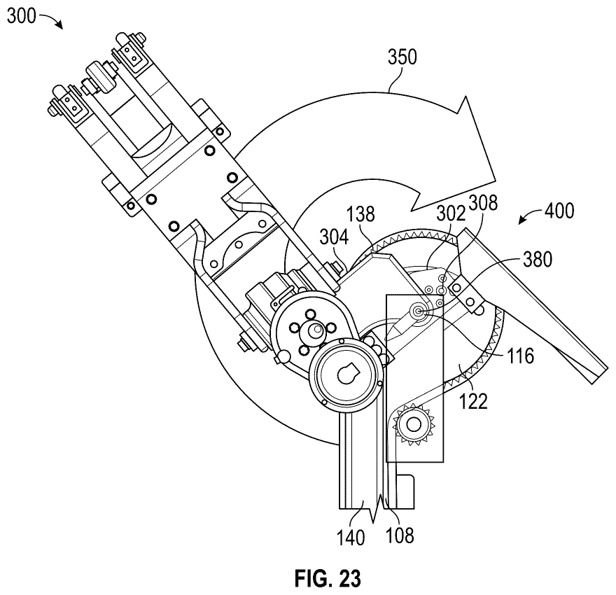

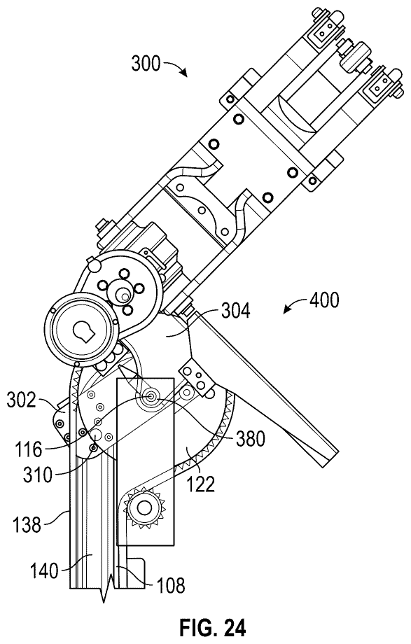

As shown in FIGS. 22-24, among others, when the grabber assembly 300 reaches a point along the track members 108 (e.g., as shown in FIG. 23), a current location of the linkage 302 is limited (e.g., prevented from traveling further along the track members 108), and the carriage 304 enters pure rotation about the sprocket 122. The carriage 304 and the grabber assembly 300 enter pure rotation about the sprocket 122 as shown in FIG. 24.

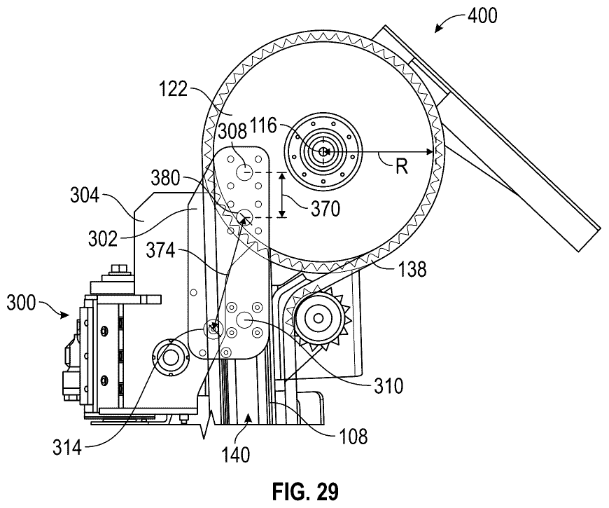

Referring to FIGS. 22 and 29, the linkage 302 extends further upwards along the track members 108 (e.g., towards the curved track members 109) past a top edge of the carriage 304. The linkage 302 includes the first member 308 disposed upwards past the top edge of the carriage 304 and the second member 310 disposed at a distal end of the linkage 302. The carriage 304 of the grabber assembly 300 is pivotally coupled with the linkage 302 at a pivot point 380 that is between the first member 308 and the second member 310. The first member 308 and the second member 310 are received within the track 140 and slide along the track 140. The pivot point 380 can include a post or a bearing in order to pivotally couple the carriage 304 with the linkage 302. The carriage 304 hangs from the linkage 302 at the pivot point 380 and can facilitate allowing the carriage 304 and the grabber assembly 300 to enter pure rotation (without translation) about the sprocket 122. In particular, the pivot point 380 may be a distance 370 below the first member 308 (e.g., with the distance 370 measured between a center of the pivot point 380 and a center of the first member 308).

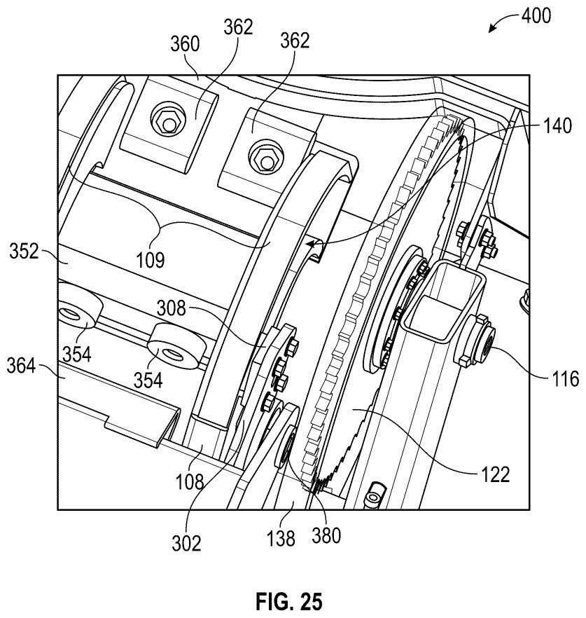

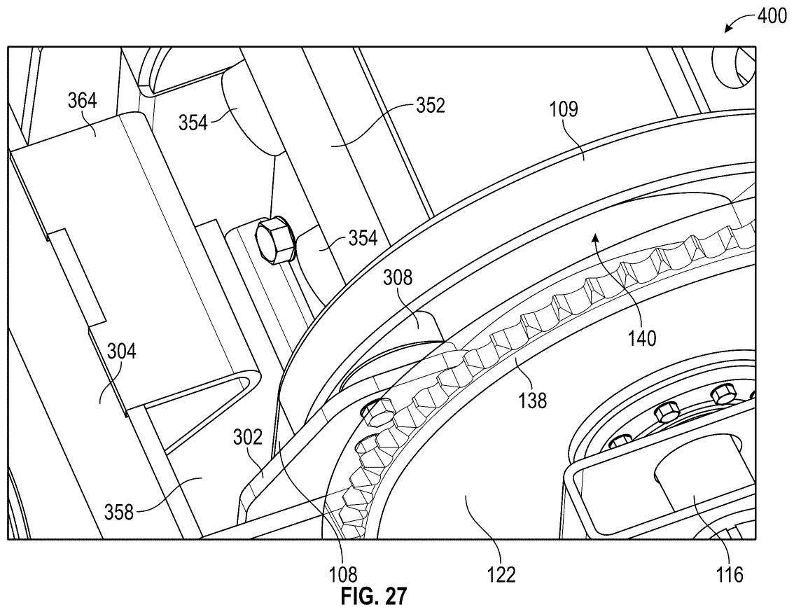

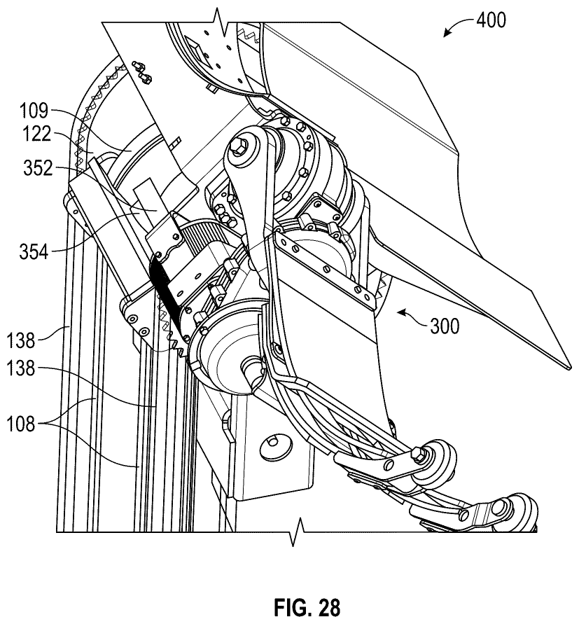

Referring to FIGS. 25-27 and 30-33, the unhinger apparatus 400 (e.g., the track 20) includes a member 352 (e.g., a bar, a beam, a web, etc.) that extends between inner surfaces of the opposing curved track members 109. The member 352 includes a pair of engagement members 354 (e.g., plastic members, rigid members, semi-flexible members, etc.) that protrude from a surface of the member 352. The pair of engagement members 354 protrude in a direction from the member 352 towards the grabber assembly 300. The engagement members 354 are configured to directly contact or abut a surface 358 of a cross-member 356 of the linkage 302 when the grabber assembly 300 (e.g., the carriage 304 and the linkage 302) reach a particular point along the track 140 (e.g., as shown in FIG. 28). The engagement members 354 contact the surface 358 in order to limit further movement of the linkage 302 upwards along the track 140. The surface 358 can be disposed at a bottom of the linkage 302 proximate the second member 310. The member 352 and the engagement members 354 are disposed on the curved track member 109 proximate a beginning of the curved track member 109 (e.g., proximate a transition between the track members 108 and the curved track member 109).

As shown in FIGS. 25-26, and 31-33, the unhinger apparatus 400 further includes a member 360 that extends between the curved track members 109. The member 360 is disposed at an end of the curved track members 109. The member 360 includes a surface upon which engagement members 362 are disposed. The engagement members 362 are configured to abut a corresponding member 364 of the carriage 304 in order to limit rotation of the carriage 304 and the grabber assembly 300 beyond the end of the curved track members 109.

Referring to FIGS. 29, 32, and 33, the chain 138 is fixed to the carriage 304 at a connection point 314. The connection point 314 is proximate a lateral side of the carriage 304. The connection point 314 is proximate the second member 310 of the linkage 302 when the carriage 304 abuts the linkage 302. The connection point 314 is disposed along the carriage 304 between an upper and lower portion of the carriage 304.

Referring particularly to FIG. 29, the connection point 314 between the carriage 304 and the pivot point 380 is disposed at a position along the carriage such that a distance 374 between the connection point 314 and the pivot point 380 (e.g., at which the carriage 304 is pivotally coupled with the linkage 302) is substantially the same as a radius R of the sprocket 122. In some embodiments, the distance 374 can be slightly greater or less than the radius R as allowed by slop of the chain 138 or tensioning of the chain 138.

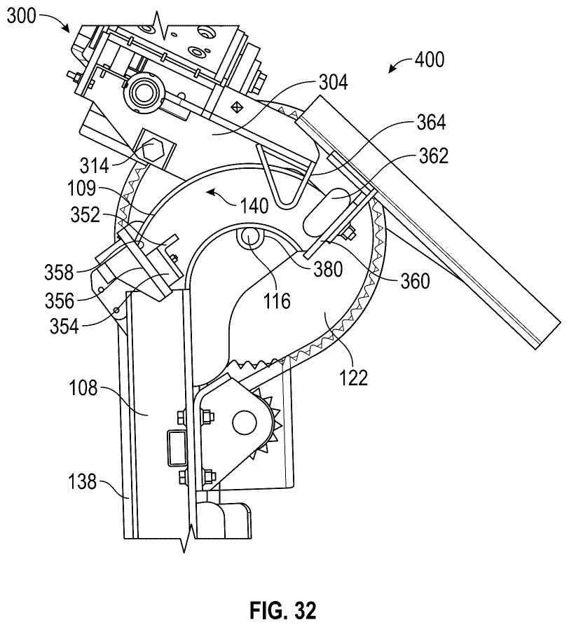

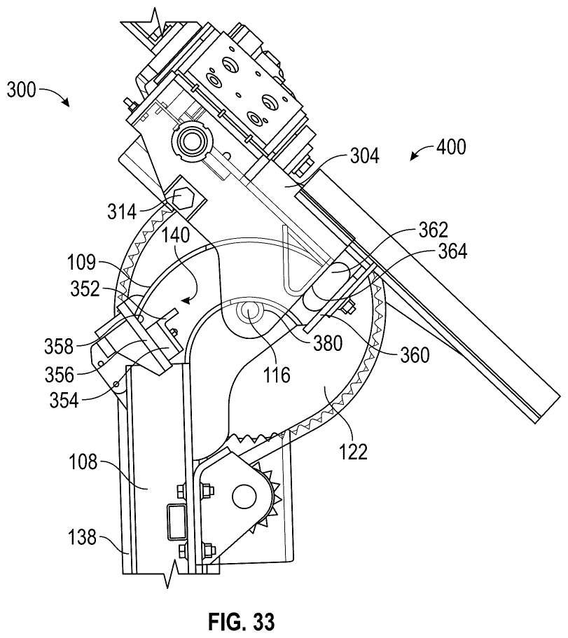

Referring particularly to FIGS. 32 and 33, when the surface 358 of the linkage 302 engages the engagement members 354, the pivot point 380 between the linkage 302 and the carriage 304 is positioned at a center of the sprocket 122. The pivot point 380 can be centered at an axis of rotation of the sprocket 122 (e.g., co-axial with the shaft 116 of the sprocket 122) such that the carriage 304 can be driven to rotate about the shaft 116. In this way, the positioning of the connection point 314 the distance 374 from the pivot point 380 (e.g., the distance 374 being substantially equal to the radius R of the sprocket 122) allows the carriage 304 to be rotated relative to the linkage 302 about the center of the sprocket 122, without corresponding translation. The positioning of the pivot point 380 and the connection point 314 is such that the pivot point 380 between the linkage 302 and the carriage 304 self-centers (e.g., is centered about the sprocket 122) when the linkage 302 is prevented from traveling further along the curved track members 109 by contact of the engagement members 354. As shown in FIG. 29, the pivot point 380 is disposed a distance 370 from the first member 308 along the linkage 302 such that, when the linkage 302 is limited from traveling further along the track 140, the pivot point 380 is centered about the sprocket 122.

Advantageously, the chain 138 can be driven (e.g., by a drive motor) to induce motion of the linkage 302 and the carriage 304 such that the grabber assembly 300 ascends and descends the track 20. When the grabber assembly 300 travels along the track members 108 (e.g., the straight portions), the carriage 304 and the linkage 302 are in direct contact (e.g., the angle 312 is substantially equal to zero). In this way, the drive motor 124 can drive the chain 138 to cause the grabber assembly 300 to ascend the track 20. Once the grabber assembly 300 (e.g., the carriage 304 and the linkage 302) reaches the point along the track 20 at which the linkage 302 is limited from moving further along the track 20, the pivot point 380 is centered at the sprocket 122 and further movement of the chain 138 causes the grabber assembly 300 (e.g., the carriage 304) to rotate about the pivot point 380 relative to the linkage 302.

### Reach Assembly

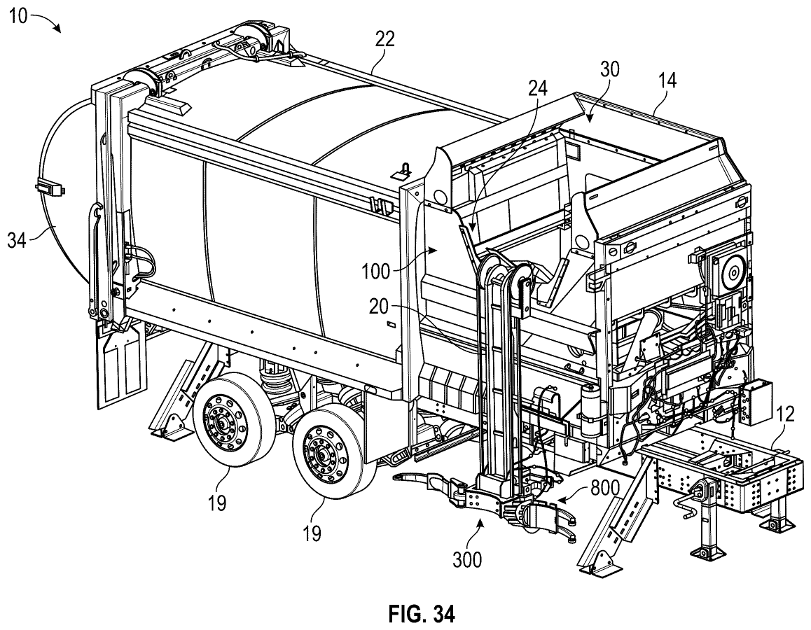

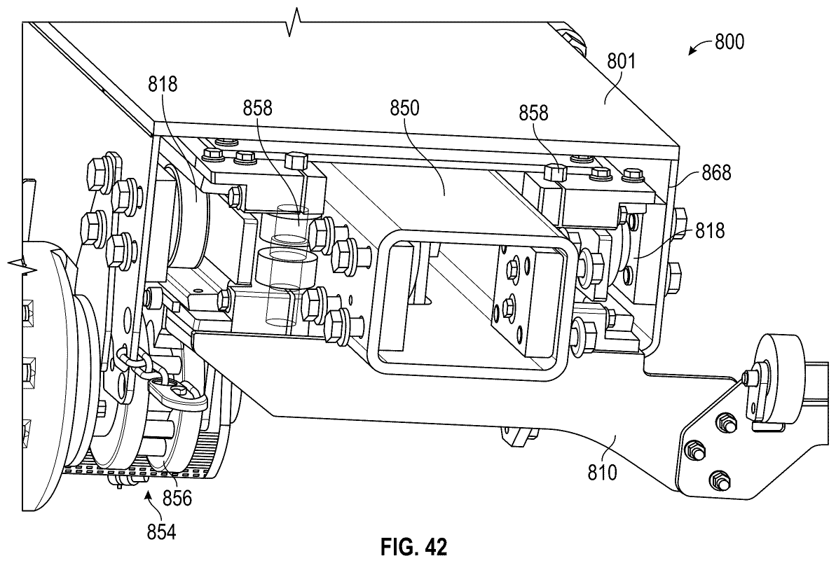

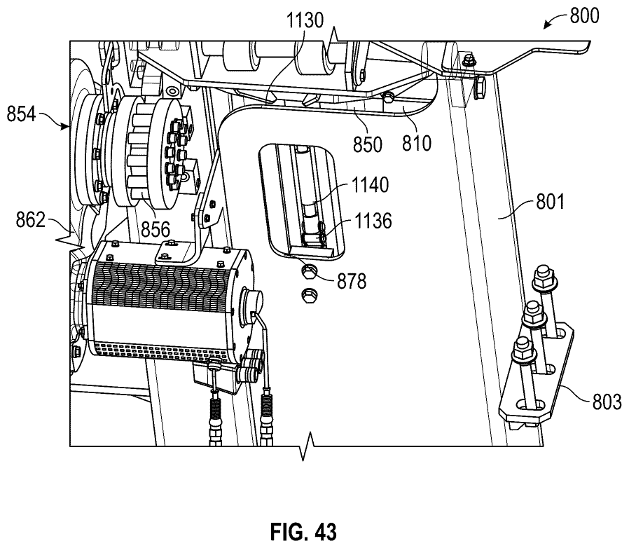

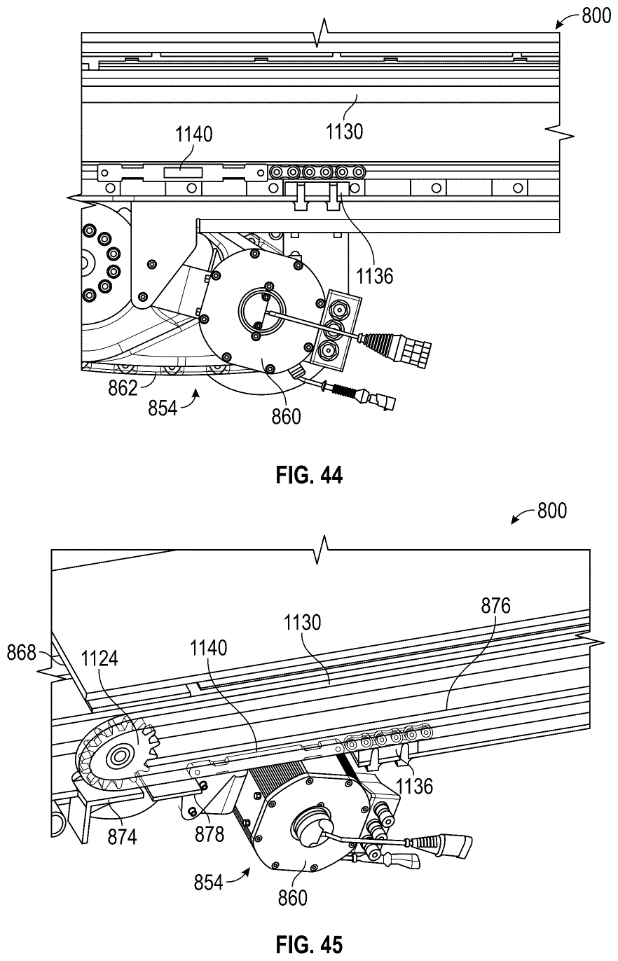

Referring to FIGS. 21 and 34-49, the refuse vehicle 10 can also include a reach assembly 800 that is configured to operate to facilitate extension and retraction of grabber assembly 300 and/or lift assembly 100. Reach assembly 800 can be configured to extend or retract from a side (e.g., a lateral side) of refuse vehicle 10 to facilitate lateral reach for grabber assembly 300 to releasably grasp refuse containers that may be positioned a lateral distance from refuse vehicle 10 (e.g., on a curbside). In some embodiments, reach assembly 800 is configured to extend or retract to laterally translate grabber assembly 300 and lift assembly 100. In some embodiments, reach assembly 800 is configured to extend or retract to laterally translate grabber assembly 300 and a portion of lift assembly 100 (e.g., a portion of track 20). Reach assembly 800 can be fixedly coupled, attached, secured, etc., with frame 12 of refuse vehicle 10 or may be fixedly coupled, attached, secured, etc., with body 14 of refuse vehicle 10.

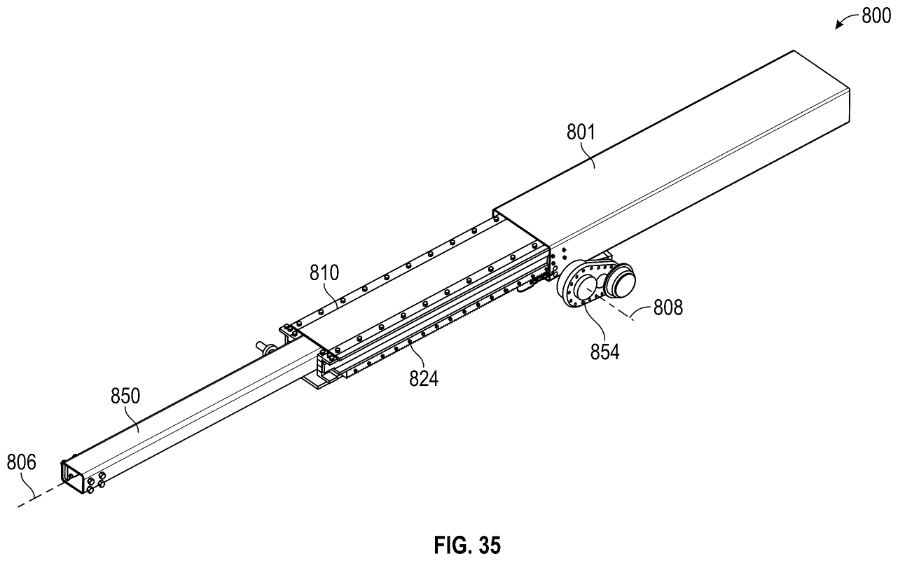

Referring to FIGS. 35-47, the reach assembly 800 includes a rear, a first, or a proximate end 864, and a front, a second, or a distal end 866. Proximate end 864 of reach assembly 800 can be removably or fixedly coupled with refuse vehicle 10. For example, proximate end 864 can be removably or fixedly coupled with frame 12, body 14, a chassis, etc., of refuse vehicle 10. Reach assembly 800 includes track 20 and grabber assembly 300 at distal end 866. Track 20 and grabber assembly 300 can be removably or fixedly coupled with distal end 866 of reach assembly 800.

Referring to FIG. 35, among others, reach assembly 800 includes a longitudinal axis 806 that extends therethrough and defines a longitudinal direction. Reach assembly 800 also includes a lateral axis 808 that extends therethrough perpendicular to longitudinal axis 806 and defines a lateral direction. In some embodiments, lateral axis 808 is substantially parallel with a longitudinal axis of refuse vehicle 10.

Reach assembly 800 includes a body, a frame, a structural support member, a telescoping member, a tracked member, an outer member, a body member, etc., shown as body 801. Body 801 can be fixedly or removably coupled with a body or frame of refuse vehicle 10 through connecting portions 803. Connecting portions 803 can extend from opposite lateral and/or longitudinal sides of body 801 and can include holes, apertures, etc., configured to receive fasteners therethrough to removably couple reach assembly 800 with refuse vehicle 10 (e.g., with an underside of refuse vehicle 10). Connecting portions 803 can be generally planar members, flanges, etc. Reach assembly 800 includes a first extendable member, a bar, a beam, a hollow member, etc., shown as extendable member 810. Extendable member 810 configured to extend or retract in the longitudinal direction relative to body 801 to facilitate grabber assembly 300 reaching various refuse containers (e.g., containers that are a distance away from refuse vehicle 10). Extendable member 810 can be configured to extend or retract in the longitudinal direction to increase or decrease an overall longitudinal length of reach assembly 800. In some embodiments, extendable member 810 is driven by an drive assembly 854. Extendable member 810 can be received within and slidably couple with an inner volume, a channel, a longitudinal track, a recess, a bore, a hollow portion, a cavity, grooves, etc., of body 801. Body 801 can have a generally rectangular or square shape and can receive extendable member 810 therewithin. The inner volume of body 801 can correspond in shape with an outer shape of extendable member 810.

Extendable member 810 includes a rack, an engagement member, a plurality of teeth, etc., shown as rack 824. Rack 824 extends longitudinally along substantially an entire length of the extendable member 810. The rack 824 can be disposed on a lateral side of the extendable member 810 or on a bottom surface of the rack 824 proximate a lateral side of the extendable member 810. Rack 824 includes teeth, projections, engagement members, protrusions, etc., shown as teeth. The teeth are spaced apart and extend along substantially an entire length of rack 824.

Drive assembly 854 can be fixedly coupled with body 801. Drive assembly 854 is configured to drive a gear, a roller pinion, an engagement member, a rotational member, a drive member, etc., shown as roller pinion 856. Roller pinion 856 is configured to engage or mesh with teeth of rack 824. Drive assembly 854 can exert a torque on roller pinion 856 through a gearbox which is transferred to a translational force through the engagement between roller pinion 856 and rack 824. Roller pinion 856 is driven to rotate by drive assembly 854, thereby translating extendable member 810 relative to body 801 in the longitudinal direction (e.g., along longitudinal axis 806). Drive assembly 854 can be operated in either direction to translate extendable member 810 relative to body 801 (e.g., to extend extendable member 810 or to retract extendable member 810). Drive assembly 854 can transfer torque to roller pinions through a gearbox. Drive assembly 854 can include a brake (e.g., an electric brake). The brake can be configured to activate to lock an output driveshaft of drive assembly 854, thereby locking reach assembly 800 at a current degree of extension or retraction.

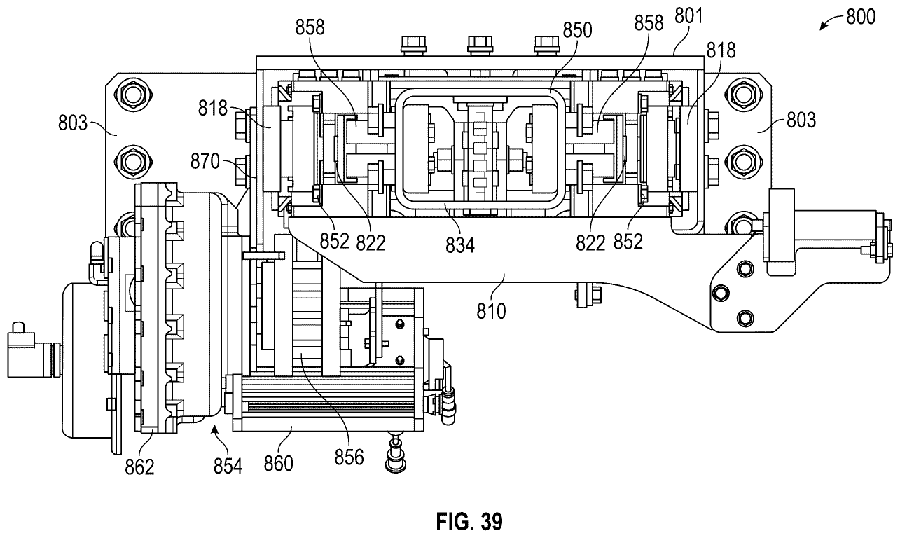

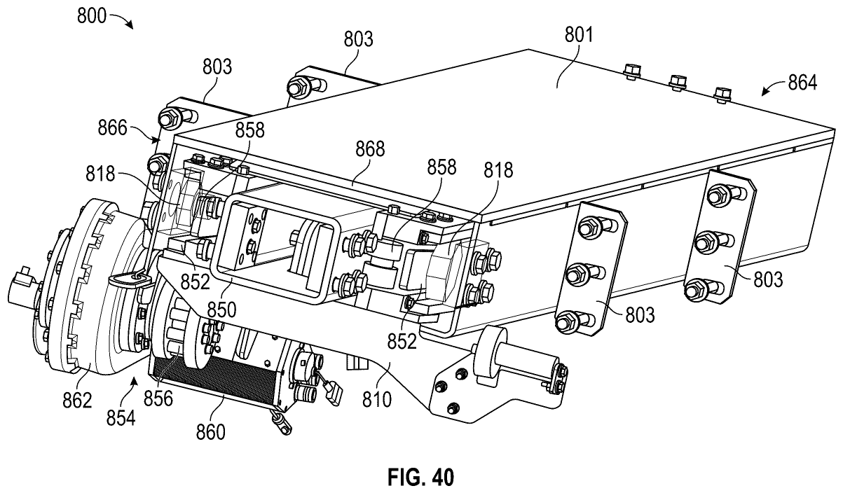

Referring to FIGS. 39 and 40, the extendable member 810 can include a first channel, an inner volume, a space, a recess, etc., shown as outer tracks 852. The outer tracks 852 are configured to receive linear bearings 818 (e.g., rollers) that are coupled to inner sides of the body 801. The extendable member 810 can also include an inner channel, shown as inner tracks 822. Extendable member 810 defines a space therebetween inner tracks 822 that can receive another extendable member, bar, elongated member, etc., shown as extendable member 850. Extendable member 850 can be received within extendable member 810. Extendable member 850 can be received through a center or extendable member 810, or can be received within a laterally offset channel of extendable member 810. In some embodiments, extendable member 850 is fixedly coupled with linear bearings or protrusions that are received within and translatably and slidably couple with inner tracks 822. In this way, extendable member 850 can translate along inner tracks 822 relative to extendable member 810. Extendable member 850 includes a body portion, a frame, an elongated member, etc., shown as body 834. Body 834 can have an outer cross sectional shape that corresponds to the shape of the space/volume defined between inner tracks 822. Body 834 is slidably and translatably coupled with inner tracks 822 of outer tracks 852. The outer tracks 852 and the inner tracks 822 can be defined by a pair of I-beams (e.g., frame members) spaced a distance apart. In some embodiments, the extendable member 810 includes other beams such as C-channels.

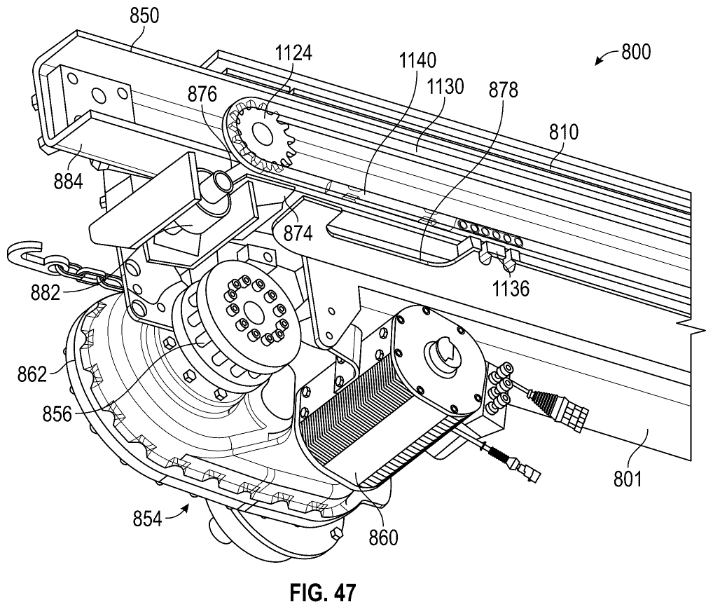

The extendable member 810 can include a pair of rollers 858 that are oriented vertically and configured to rotate about a vertical axis. The rollers 858 are disposed in the inner tracks 822 and are configured to engage or abut an outer surface of the body 834 of the extendable member 850 in order to facilitate relative motion between the extendable member 850 and the extendable member 810. As shown in FIG. 47, the extendable member 810 can also include a bottom roller 882 that is disposed on the outer end 1132 of the extendable member 810. The bottom roller 882 is configured to engage a bottom surface 884 of the extendable member 850 and be driven to rotate as the extendable member 850 moves relative to the extendable member 810.

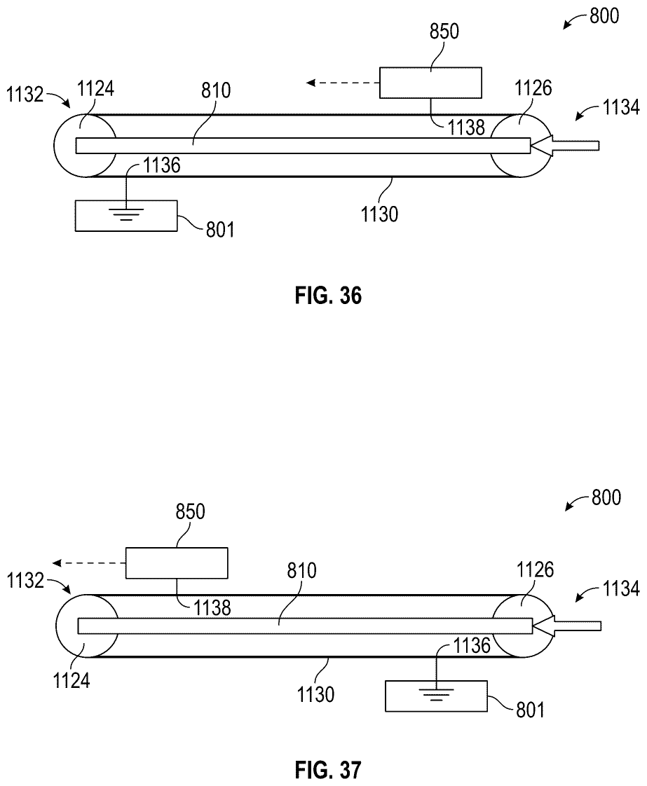

Referring to FIGS. 36-38, the reach assembly 800 includes a chain 1130 (e.g., a tensile member, a band, a belt, etc.), a first sprocket 1124 (e.g., a roller, a rotatable member, a pulley, etc.), and a second sprocket 1126 (e.g., a second roller, rotatable member, pulley, etc.). The first sprocket 1124 is rotatably coupled at an outer end 1132 (e.g., a proximate end, a fore end, a first end, etc.) of the extendable member 810 that is more distal from the refuse vehicle 10. The second sprocket 1126 is rotatably coupled at an inner end 1134 of the extendable member 810 that is more proximate the refuse vehicle 10. The first sprocket 1124 and the second sprocket 1126 are translationally fixedly coupled with the extendable member 810 at opposite ends. The first sprocket 1124 and the second sprocket 1126 engage the chain 1130 and facilitate relative motion between the extendable member 810 and the extendable member 850.

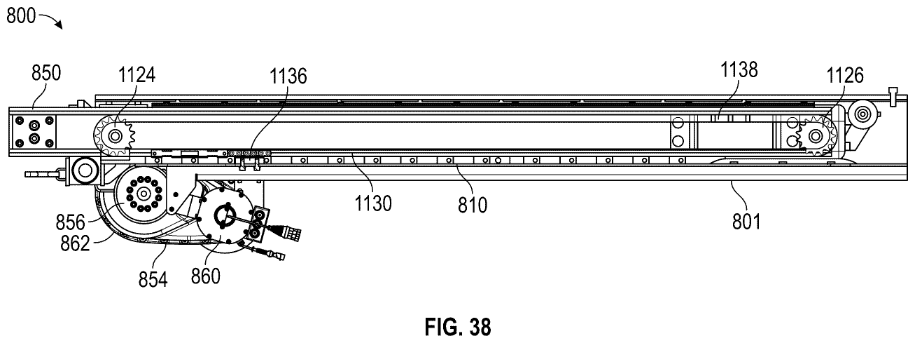

The body 801 is fixedly coupled (e.g., mounted, anchored, etc.) with the chain 1130 at a first connection point 1136. The extendable member 850 is fixedly coupled (e.g., mounted, anchored, etc.) with the chain 1130 at a second connection point 1138. When the reach assembly 800 is in a retracted position or state as shown in FIGS. 36 and 38, the connection point 1138 is proximate the inner end 1134 of the extendable member 810. When the reach assembly 800 is in the retracted state as shown in FIGS. 36 and 38, the first connection point 1136 is proximate the outer end 1132 of the extendable member 810. The first connection point 1136 and the second connection point 1138 are disposed on opposite sides (e.g., opposite vertical sides) of the first sprocket 1124 and the second sprocket 1126. The first connection point 1136 and the second connection point 1138 at which the chain 1130 is fixed to the body 801 and the extendable member 850, respectively, are defined on opposite lengthwise portions of the chain 1130 on opposite sides of the first sprocket 1124 and the second sprocket 1126. For example, the second connection point 1138 at which the chain 1130 is fixed to the extendable member 850 can be above an axis defined between center points of the first sprocket 1124 and the second sprocket 1126 and the first connection point 1136 at which the chain 1130 is fixed to the body 801 can be below the axis defined between center points of the first sprocket 1124.

The reach assembly 800 can be driven into the extended state as shown in FIGS. 35 and 37 by driving the extendable member 810 to translate relative to the body 801. The relative motion (e.g., translation) of the extendable member 810 relative to the body or, more specifically, extension of the extendable member 810 out of the inner volume of the body 801, causes the chain 1130 to drive rotation of the sprockets 1124 and 1126. The chain 1130 thereby drives the extendable member 850 to translate relative to the extendable member 810 in a same direction as the motion of the extendable member 810 relative to the body 801. In this way, driving translation of the extendable member 810 relative to the body 801 (e.g., a distance Δx) causes a corresponding amount of motion (e.g., the distance Δx) of the extendable member 850 relative to the extendable member 810, thereby producing relative motion between the body 801 (e.g., the refuse vehicle 10) and the extendable member 850 (e.g., the lift assembly 100 and the grabber assembly 42) that is double the relative motion of the extendable member 810 relative to the body 801 or the extendable member 850 relative to the extendable member 810 (e.g., a distance 2×Δx).

When the reach assembly 800 is transitioned into the extended position shown in FIGS. 35 and 37, the second connection point 1138 is translated towards the distal end 1132 and the first connection point 1136 is stationary. The first sprocket 1124 and the second sprocket 1126 are coupled to the extendable member 810 such that translation of the extendable member 810 relative to the body 801 causes the first sprocket 1124 and the second sprocket 1126 to also be translated relative to the body 801. The first connection point 1136 is therefore transitioned towards the inner end 1134 of the extendable member 810 due to movement of the extendable member 810 relative to the second connection point 1136.

Referring to FIG. 35, and 38-47, the drive assembly 854 includes an electric motor 860, a gearbox 862 and a pinion 856. The electric motor 860 is configured to drive the pinion 856 through the gearbox 862. The pinion 856 can be a rotatable member including a plurality of pins (e.g., cylindrical members) disposed along a circumference about an axis about which the pinion 856 is configured to rotate. The pinion 856 (e.g., the pins) are configured to engage (e.g., mesh with) teeth of the rack 824 of the extendable member 810. The electric motor 860 can therefore drive motion of the extendable member 810 which therefore causes corresponding relative motion of the extendable member 850. As shown in FIGS. 39-42, among others, the drive assembly 854 is coupled at a distal end 866 of the body 801, proximate an opening 868 of the body 801 through which the extendable member 810 and the extendable member 850 extend. The drive assembly 854 can be coupled to a lateral side 870 of the body 801. The drive assembly 854 extends below the body 801. When the body 801 is installed on the refuse vehicle 10, the drive assembly 854 is disposed the body 14 and may be disposed lower than the chassis 12. The drive assembly 854 can be suspended below the body 801.

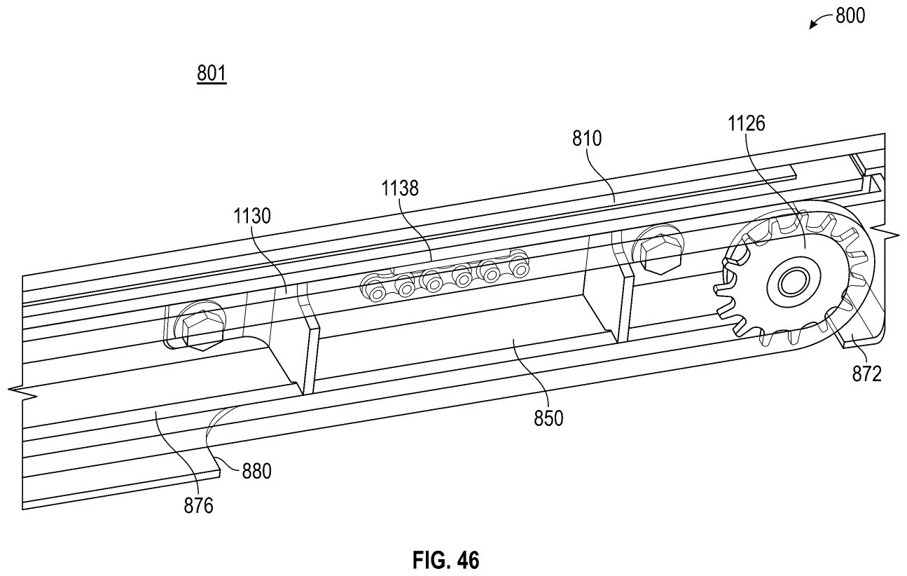

Referring to FIG. 46, among others, the second sprocket 1126 is shown disposed within the body 801 (e.g., the inner volume of the body 801 within which both the extendable member 810 and the extendable member 850 are disposed). The second sprocket 1126 is rotatably coupled to a bracket 872 that is positioned at the inner end 1134 of the extendable member 810. The bracket 872 can be a vertically oriented member that protrudes from the inner end 1134 of the extendable member 850 towards the outer end 1132.

Referring to FIGS. 45 and 47, among others, the first sprocket 1124 is disposed in the inner volume of the extendable member 810 and the extendable member 850. The first sprocket 1124 is coupled to a bracket 874. The bracket 874 is disposed on a bottom side of the extendable member 810 and protrudes upwards into the inner volume of the extendable member 810. The first sprocket 1124 is rotatably coupled with the bracket 874. The extendable member 850 includes an opening 876 that extends lengthwise along the extendable member 850 in a bottom face of the extendable member 850. The opening 876 provides a space so that the extendable member 850 can move relative to the extendable member 810 with the sprocket 1124 protruding upwards through the opening 876.

Referring to FIGS. 38, 43-45, and 47, the first connection point 1136 between the chain 1130 and the body 801 is positioned proximate a turnbuckle 1140 of the chain 1130. The first connection point 1136 fixedly couples a portion of the chain 1130 adjacent the turnbuckle 1140 to the body 801. The turnbuckle 1140 is coupled at opposite ends with ends of the chain 1130. The turnbuckle 1140, the first sprocket 1124, and the first connection point 1136 are accessible by and proximate a first access opening 878 (e.g., an aperture, a hole, etc.). The first access opening 878 is formed in the bottom surface of the body 801. The first access opening 878 is proximate an outer end of the body 801 (e.g., proximate the opening 868 through which the extendable member 810 and the extendable member 850 are received and extend). The first access opening 878 facilitates access of the turnbuckle 1140 and the first connection point 1136 in order to either adjust the turnbuckle 1140 (e.g., with a tool) to adjust a tension of the chain 1130, or to couple or de-couple the chain 1130 from the body 801 at the first connection point 1136.

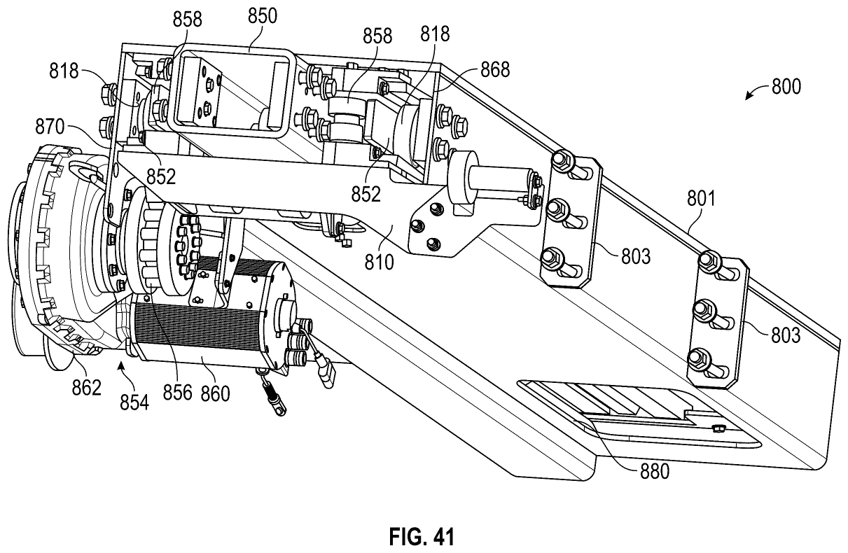

Referring to FIGS. 41 and 46, the body 801 can include a second access opening 880 formed in the bottom of the body 801. The second access opening 880 is at an end of the body 801 opposite the first access opening 878. The second access opening 880 is proximate the connection point 1138 when the reach assembly 800 is in the retracted position. The second access opening 880 facilitates access to the second connection point 1138 (e.g., through the second access opening 880 and the opening 876 of the extendable member 850) at which the chain 1130 is fixed to the extendable member 850. The second access opening 880 facilitates access to the second connection point 1138 for installation and removal of the chain 1130 or other servicing of the chain 1130.

Referring to FIGS. 35, 38-45, and 47, the reach assembly 800 can be controlled to provide two-stage motion (e.g., the extendable member 810 relative to the body 801, and the extendable member 850 relative to the extendable member 810) while only driving motion of a single one of the extendable member 810 or the extendable member 850. The embodiment described herein describes the driving of motion of the extendable member 850 by using a rack and pinion driven by an electric motor. However, the embodiments described herein should not be understood as limiting. For example, the extendable member 850 can be driven to move by use of an electric linear actuator, a separate chain drive, a worm drive, etc., or any other mechanism to drive motion of the extendable member 850. In some embodiments, the extendable member 850 is directly driven to move relative to the extendable member 810 instead of the extendable member 810 being driven relative to the body 801. Advantageously, the reach assembly 800 provides a system that enables relative motion of a second member relative to a first member, and a third member relative to the second member, while only requiring a single primary mover (e.g., an electric motor) to drive one of the second member or the third member.

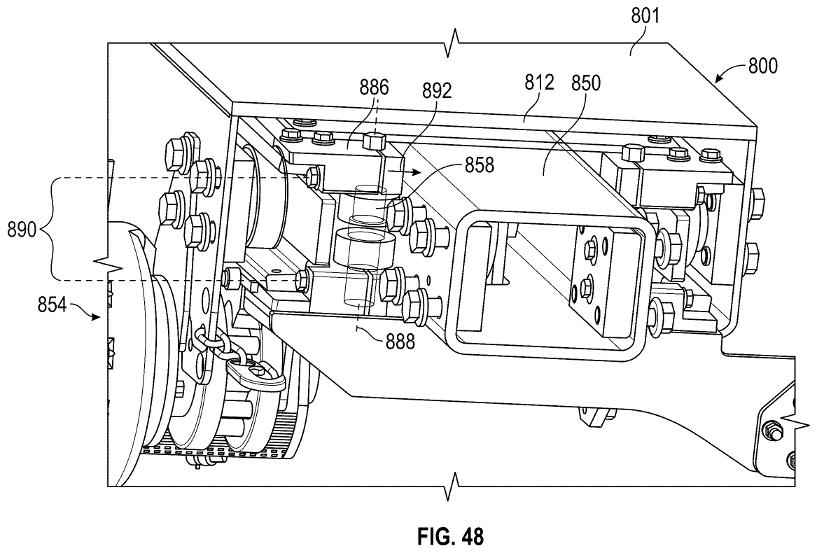

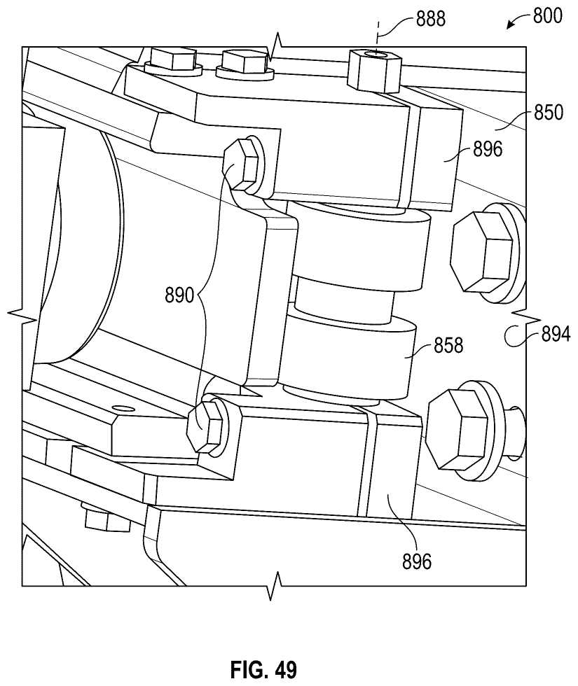

Referring to FIGS. 48 and 49, the rollers 858 can be mounted on an eccentric pin 886. The eccentric pin 886 can be rotated about an axis 888 that extends in a vertical direction to drive movement of the rollers 858 towards the extendable member 850 (e.g., in a direction 892) or away from the extendable member 850. When the rollers 858 are moved in the direction 892 (e.g., into further engagement with an outer surface 894 of the extendable member 850), a tension or degree of frictional engagement between the roller 858 and the extendable member 850 increases. The eccentric pin 886 is disposed between brackets 896. The brackets 896 can be split having a slot formed on one end. The eccentric pin 886 can be driven to rotate to thereby move the rollers 858 by using a tool on a tool interfacing end (e.g., a hex nut). In order to adjust the eccentric pin 886, one or more fasteners 890 that control a degree of engagement between the brackets 896 and the eccentric pin 886 can be loosened, the eccentric pin 886 rotated, and the fasteners 890 re-tightened. The fasteners 890 can be threaded through both portions of the split of the brackets 896 in order to drive the split portions of the brackets 896 towards each other to engage the eccentric pin 886. The roller 882 can similarly be disposed on an eccentric pin with similar adjustment members.

It should also be noted that any of the electric motors, electric linear actuators, etc., can include a brake that can lock or facilitate restricting rotational output from an output driveshaft of any of the electric motors. For example, any of the electric motors can include a drum brake configured to activate and provide a frictional force to the electric motor driveshaft to facilitate preventing rotation of the driveshaft thereof. The brake can be activated using mechanical systems, or an electrical system. For example, the brake may be an electrically activated drum brake, a mechanical brake, an electrical brake, etc. The brake can be configured to decrease output speed of the driveshaft of the electric motor or to facilitate locking a current angular position of the driveshaft of the electric motor. The brake can be operated by the same controller or control system that operates the electric motors and electric linear actuators, or can be operated by a separate control system and/or a separate controller. Additionally, any of the electric motors or linear electric actuators described herein can include appropriate gearboxes to increase or decrease output torque. The brake can be activated when the refuse vehicle is shut down, or when the reach apparatus is powered off, or in response to a user input.

It should also be noted that any of the electrical motors, electrical actuators, or any other electrical movers can include any number of sensors configured to measure and monitor an angular position or a degree of extension. In some embodiments, the sensors are a component of the electric motors or the electric linear actuators and provide feedback signals to a controller.

The controller can monitor the sensor signals to identify an angular position or a degree of extension of the electric motors or the electric linear actuators, respectively. The controller can use the sensor signal to determine a current degree of extension of reach assembly 800. In some embodiments, extension of reach assembly 800 is directly measured (e.g., with a distance sensor, with a proximity sensor, etc.).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A refuse vehicle, comprising:
a reach assembly, comprising:
a body coupled to the refuse vehicle, the body defining a first inner volume;
a first extendable member configured to be received within and extend from the first inner volume, the first extendable member defining a second inner volume;
a second extendable member configured to be received within and extend from the second inner volume;
a chain disposed within an inner volume of the second extendable member, the chain configured to engage sprockets coupled at opposite ends of the first extendable member, the chain fixed to the body at a first connection point and fixed to the second extendable member at a second connection point; and
an electric motor configured to drive motion of the first extendable member relative to the body, wherein driving relative motion of the first extendable member to the body results in the second extendable member translating a corresponding degree of motion relative to the first extendable member; and
a lift apparatus and grabber assembly coupled with an end of the second extendable member.

2. The refuse vehicle of claim 1, wherein the reach assembly comprises:
a rack positioned on the first extendable member; and
a drive assembly comprising the electric motor and a pinion, the pinion configured to engage the rack and be driven by the electric motor to drive translation of the first extendable member relative to the body.

3. The refuse vehicle of claim 2, wherein the drive assembly is fixedly coupled to the body.

4. The refuse vehicle of claim 2, wherein the drive assembly further comprises a gearbox configured to be driven by the electric motor and drive the pinion.

5. The refuse vehicle of claim 2, wherein the drive assembly further comprises:
a turnbuckle fixed on opposite ends with ends of the chain, wherein the turnbuckle is adjustable to adjust a tension of the chain.

6. The refuse vehicle of claim 5, wherein the body comprises a first access opening disposed proximate the turnbuckle and the first connection point in a bottom of the body, wherein the first access opening allows access to the turnbuckle and the first connection point.

7. The refuse vehicle of claim 6, wherein the body comprises a second access opening disposed proximate the second connection point in a bottom of the body, wherein the second connection point is accessible through the second access opening and an opening in the second extendable member.

8. The refuse vehicle of claim 1, wherein the reach assembly is configured to be driven between a retracted state and an extended state.

9. The refuse vehicle of claim 8, wherein, in the retracted state, the first extendable member and the second extendable member are disposed within the first inner volume of the body and in the extended state, the first extendable member and the second extendable member are extended from the first inner volume of the body and protrude outwards from the first inner volume of the body.

10. The refuse vehicle of claim 8, wherein, in the retracted state, the first connection point is proximate an outer end of the first extendable member and the second connection point is proximate an inner end of the first extendable member.

11. The refuse vehicle of claim 8, wherein, in the extended state, the first connection point is proximate an inner end of the first extendable member and the second extendable member is proximate an outer end of the first extendable member.

12. The refuse vehicle of claim 1, wherein the first extendable member comprises a pair of tracks disposed on opposite outer sides of the first extendable member, the pair of tracks configured to receive linear bearings or rollers disposed on inner sides of the body.

13. The refuse vehicle of claim 1, wherein the reach assembly further comprises a roller disposed on an eccentric shaft that is coupled with an end of the first extendable member, the roller configured to engage an outer surface of the second extendable member, wherein the eccentric shaft is rotatable to adjust a degree of engagement between the roller and the outer surface of the second extendable member.

14. A reach assembly for a refuse vehicle, the reach assembly comprising:
a body coupled to the refuse vehicle, the body defining a first inner volume;
a first extendable member configured to be received within and extend from the first inner volume, the first extendable member defining a second inner volume;
a second extendable member configured to be received within and extend from the second inner volume;
a chain disposed within an inner volume of the second extendable member, the chain configured to engage sprockets coupled at opposite ends of the first extendable member, the chain fixed to the body at a first connection point and fixed to the second extendable member at a second connection point; and
an electric motor configured to drive motion of the first extendable member relative to the body, wherein driving relative motion of the first extendable member to the body results in the second extendable member translating a corresponding degree of motion relative to the first extendable member.

15. The reach assembly of claim 14, further comprising:
a rack positioned on the first extendable member; and
a drive assembly comprising the electric motor and a pinion, the pinion configured to engage the rack and be driven by the electric motor to drive translation of the first extendable member relative to the body.

16. The reach assembly of claim 14, further comprising:
a turnbuckle fixed on opposite ends with ends of the chain, wherein the turnbuckle is adjustable to adjust a tension of the chain.

17. The reach assembly of claim 14, wherein the body comprises a first access opening disposed proximate a turnbuckle and the first connection point in a bottom of the body, wherein the first access opening allows access to the turnbuckle and the first connection point.

18. The reach assembly of claim 14, wherein the body comprises a second access opening disposed proximate the second connection point in a bottom of the body, wherein the second connection point is accessible through the second access opening and an opening in the second extendable member.

19. The reach assembly of claim 14, wherein the first extendable member comprises a pair of tracks disposed on opposite outer sides of the first extendable member, the pair of tracks configured to receive linear bearings or rollers disposed on inner sides of the body, wherein the reach assembly further comprises a roller disposed on an eccentric shaft that is coupled with an end of the first extendable member, the roller configured to engage an outer surface of the second extendable member, wherein the eccentric shaft is rotatable to adjust a degree of engagement between the roller and the outer surface of the second extendable member.

20. A refuse vehicle, comprising:
a reach assembly, comprising:
a body coupled to the refuse vehicle, the body defining a first inner volume;
a first extendable member configured to be received within and extend from the first inner volume, the first extendable member defining a second inner volume; and
a second extendable member configured to be received within and extend from the second inner volume;
a tensile member disposed within an inner volume of the second extendable member, the tensile member configured to engage rotatable members coupled at opposite ends of the first extendable member, the tensile member fixed to the body at a first connection point and fixed to the second extendable member at a second connection point; and
an electric motor configured to drive motion of the first extendable member relative to the body, wherein driving relative motion of the first extendable member to the body results in the second extendable member translating a corresponding degree of motion relative to the first extendable member; and
a lift apparatus and grabber assembly coupled with an end of the second extendable member.
